(19) United States
(12) Patent Application Publication
(10) Pub. No.: US 2026/0211709 A1
(43) Pub. Date: Jul. 23, 2026

(54) RECOMMENDATION CARD DISPLAY

(71) Applicant: TENCENT TECHNOLOGY (SHENZHEN) COMPANY LIMITED, Shenzhen (CN)

(72) Inventors: Mingyang LI, Shenzhen (CN); Wenjing LU, Shenzhen (CN); Guoning ZHANG, Shenzhen (CN); Xiangdong ZHU, Shenzhen (CN)

(73) Assignee: TENCENT TECHNOLOGY (SHENZHEN) COMPANY LIMITED, Shenzhen, GD (CN)

(21) Appl. No.: 19/569,806

(22) Filed: Mar. 17, 2026

Related U.S. Application Data
(63) Continuation of application No. PCT/CN2024/110409, filed on Aug. 7, 2024.

(30) Foreign Application Priority Data
Nov. 10, 2023 (CN) 202311502837.1

(51) Int. Cl. G06F 9/451; G06F 3/04847

(52) U.S. Cl. CPC G06F 9/451; G06F 3/04847

(57) ABSTRACT

In a recommendation card display method, at least two recommendation cards including recommended content are displayed in a view interface at initial positions in a clustered state. A ratio of a first area to a second area is less than a first ratio. The first area is a sum of visible areas of the at least two recommendation cards, and the second area is a sum of total areas of the at least two recommendation cards. When a separation condition is satisfied, the at least two recommendation cards are controlled to move from the initial positions to target positions. The at least two recommendation cards are displayed in a separated state when the at least two recommendation cards are at the target positions. In the separated state, the ratio of the first area to the second area is not less than a second ratio greater than the first ratio.

### RELATED APPLICATIONS

The present application is a continuation of International Application No. PCT/CN2024/110409, filed on Aug. 7, 2024, which claims priority to Chinese Patent Application No. 202311502837.1, filed on Nov. 10, 2023. The entire disclosures of the prior applications are hereby incorporated by reference.

### FIELD OF THE TECHNOLOGY

This disclosure relates to the field of Internet technologies, including a recommendation card presentation method and apparatus, an electronic device, a computer-readable storage medium, and a computer program product.

### BACKGROUND OF THE DISCLOSURE

In a related technology, when recommendation cards are presented, the recommendation cards are mostly arranged in a fixed pattern. Then, different recommendation resources are fetched from a server end to refresh content with which the recommendation cards are filled, thereby presenting the recommendation cards fixedly arranged. However, such a recommendation card presentation manner results in a lack of variation and recognizability in recommendation slots, which leads to a relatively monotonous presentation process of the recommendation cards, thereby resulting in lower utilization of the recommendation cards and lower human-computer interaction efficiency.

### SUMMARY

Embodiments of this disclosure provide a recommendation card presentation method and apparatus, an electronic device, a computer-readable storage medium, and a computer program product, which can improve utilization of recommendation cards, human-computer interaction efficiency, and utilization of hardware processing resources.

An aspect of this disclosure provides a recommendation card display method. In the method, at least two recommendation cards are displayed in a view interface at initial positions in a clustered state. The at least two recommendation cards include recommended content. A ratio of a first area to a second area is less than a first ratio in the clustered state. The first area is a sum of visible areas of the at least two recommendation cards, and the second area is a sum of total areas of the at least two recommendation cards. When the at least two recommendation cards satisfy a separation condition, the at least two recommendation cards are controlled to move from the initial positions to target positions. The at least two recommendation cards are displayed in a separated state when the at least two recommendation cards are at the target positions. In the separated state, the ratio of the first area to the second area is not less than a second ratio. The second ratio is greater than the first ratio.

An aspect of this disclosure provides an information processing apparatus including processing circuitry. The processing circuitry is configured to display, in a view interface, at least two recommendation cards at initial positions in a clustered state, the at least two recommendation cards including recommended content, a ratio of a first area to a second area being less than a first ratio in the clustered state, the first area being a sum of visible areas of the at least two recommendation cards, and the second area being a sum of total areas of the at least two recommendation cards. The processing circuitry is configured to control, when the at least two recommendation cards satisfy a separation condition, the at least two recommendation cards to move from the initial positions to target positions. The processing circuitry is configured to display the at least two recommendation cards in a separated state when the at least two recommendation cards are at the target positions. In the separated state, the ratio of the first area to the second area is not less than a second ratio, the second ratio being greater than the first ratio.

An aspect of this disclosure provides a non-transitory computer-readable storage medium storing instructions which when executed by at least one processor cause the at least one processor to perform a recommendation card display method. In the method, at least two recommendation cards are displayed in a view interface at initial positions in a clustered state. The at least two recommendation cards include recommended content. A ratio of a first area to a second area is less than a first ratio in the clustered state. The first area is a sum of visible areas of the at least two recommendation cards, and the second area is a sum of total areas of the at least two recommendation cards. When the at least two recommendation cards satisfy a separation condition, the at least two recommendation cards are controlled to move from the initial positions to target positions. The at least two recommendation cards are displayed in a separated state when the at least two recommendation cards are at the target positions. In the separated state, the ratio of the first area to the second area is not less than a second ratio. The second ratio is greater than the first ratio.

An aspect of this disclosure provides a recommendation card presentation method, including: presenting, in a view interface, at least two recommendation cards in a clustered state, the recommendation cards being configured to carry recommended content; in the clustered state, the recommendation cards being at initial positions, and a ratio of a first area to a second area being less than a first ratio; and the first area being a sum of presented card areas of the recommendation cards, and the second area being a sum of card areas of the recommendation cards; and displaying, when the at least two recommendation cards satisfy a separation condition, a process of moving the recommendation cards from the initial positions to target positions, and presenting the at least two recommendation cards in a separated state when the recommendation cards are all at the target positions; in the separated state, the ratio of the first area to the second area being no less than a second ratio, and the second ratio being greater than the first ratio.

An aspect of this disclosure provides a recommendation card presentation apparatus, including: a presentation module, configured to present, in a view interface, at least two recommendation cards in a clustered state, the recommendation cards being configured carry to recommended content; in the clustered state, the recommendation cards being at initial positions, and a ratio of a first area to a second area being less than a first ratio; and the first area being a sum of presented card areas of the recommendation cards, and the second area being a sum of card areas of the recommendation cards; and a display module, configured to display, when the at least two recommendation cards satisfy a separation condition, a process of moving the recommendation cards from the initial positions to target positions, and present the at least two recommendation cards in a separated state when the recommendation cards are all at the target positions; in the separated state, the ratio of the first area to the second area being no less than a second ratio, and the second ratio being greater than the first ratio.

An aspect of this disclosure provides an electronic device, including: a memory, configured to store computer-executable instructions; and a processor, configured to implement the recommendation card presentation methods provided in the embodiments of this disclosure when executing the computer-executable instructions stored in the memory.

An aspect of this disclosure provides a computer-readable storage medium, such as a non-transitory computer-readable storage medium, having a computer-executable instructions stored therein, the computer-executable instruction, when executed by a processor, cause the processor to implement the recommendation card presentation methods provided in the embodiments of this disclosure.

An aspect of this disclosure provides a computer program product or a computer program, the computer program product or the computer program including a computer-executable instruction, the computer-executable instruction being stored in a computer-readable storage medium. A processor of an electronic device reads the computer-executable instruction from the computer-readable storage medium, and the processor executes the computer-executable instruction, to enable the electronic device to perform the recommendation card presentation methods provided in the embodiments of this disclosure.

The aspects of this disclosure include the following beneficial effects:

Firstly, at least two recommendation cards in a clustered state are presented in a view interface. Then, when the at least two recommendation cards satisfy a separation condition, a process of moving the recommendation cards from initial positions to target positions is displayed, and when the recommendation cards are all at the target positions, the at least two recommendation cards in a separated state are presented. In this way, compared with the presentation manner of the recommendation cards mostly arranged in a fixed pattern, in this disclosure, when the at least two recommendation cards satisfy the separation condition, the recommendation cards are controlled to move from the initial positions to the target positions, to switch the recommendation cards from the clustered state to the separated state, thereby implementing dynamic presentation of the recommendation cards, which enriches diversity of a presentation process of the recommendation cards, improves utilization of the recommendation cards, human-computer interaction efficiency, and utilization of hardware processing resources, and can also better attract users, helping to improve conversion efficiency of recommended content carried in the recommendation cards.

### BRIEF DESCRIPTION OF THE DRAWINGS

FIG. 1 is a schematic architectural diagram of a recommendation card presentation system according to an embodiment of this disclosure.

FIG. 2 is a schematic structural diagram of an electronic device according to an embodiment of this disclosure.

FIG. 3 is a schematic flowchart of a recommendation card presentation method according to an embodiment of this disclosure.

FIG. 4 is a schematic diagram of a first area and a second area according to an embodiment of this disclosure.

FIG. 5 is a schematic diagram of initial positions and target positions of recommendation cards according to an embodiment of this disclosure.

FIG. 6 is a schematic diagram of initial coordinates and target coordinates of recommendation cards according to an embodiment of this disclosure.

FIG. 7 is a schematic flowchart of a recommendation card update process according to an embodiment of this disclosure.

FIG. 8 is a schematic diagram of a card update control according to an embodiment of this disclosure.

FIG. 9 is a schematic diagram of a process of respectively updating recommendation cards to new recommendation cards according to an embodiment of this disclosure.

FIG. 10 is a schematic diagram of new recommendation cards in a separated state according to an embodiment of this disclosure.

FIG. 11 is a schematic diagram of initial coordinates of new recommendation cards according to an embodiment of this disclosure.

FIG. 12 is a schematic flowchart of a solution of dynamically presenting recommended content according to an embodiment of this disclosure.

### DESCRIPTION OF EMBODIMENTS

To make the objectives, technical solutions, and advantages of this disclosure clearer, embodiments of this disclosure will be described in further detail below with reference to the accompanying drawings. The described embodiments are not to be considered as a limitation on the embodiments of this disclosure. Other embodiments are within the scope of this disclosure.

“Some embodiments” involved in the following description describes a subset of all possible embodiments. However, “some embodiments” may be the same subset or different subsets of all the possible embodiments, and may be combined with each other when there is no conflict.

In the following description, the terms “first”, “second”, and “third” are merely intended to distinguish similar objects and do not represent a specific order of the objects. The terms “first”, “second”, and “third” may, where permitted, be interchangeable in a particular order or sequence, so that embodiments of this disclosure described herein may be performed in an order other than that illustrated or described herein.

In the following description, the use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Unless otherwise defined, meanings of all technical and scientific terms used herein are the same as those usually understood by a person skilled in the art to which this disclosure belongs. The examples of terms used herein are merely intended to describe the objectives of the embodiments of this disclosure, and are not intended to limit this disclosure.

Before the embodiments of this disclosure are further described in detail, examples of nouns and terms in the embodiments of this disclosure are described, and the nouns and terms in the embodiments of this disclosure are applicable to the following explanations. The descriptions of the terms are provided as examples only and are not intended to limit the scope of the disclosure.

(1) A client is a program corresponding to a server that provides a local service for a user. In addition to some applications that can only run locally, the client may be installed on an ordinary client machine and needs to cooperate with the server to run. In other words, the client requires a corresponding server and service program in a network to provide a corresponding service. In this way, a specific communication connection needs to be established between the client and a server side, to ensure normal operation of the application, such as an autonomous driving client (e.g., a map navigation client).

(2) Artificial intelligence (AI) involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have functions of perception, reasoning, and decision-making.

(3) A recommendation card is a message dynamically rendered based on templates and recommended content, where all templates and recommended content are delivered by service customization.

(4) “In response to” is configured to represent a condition or a state on which an executed operation depends, and when a dependent condition or status is met, one or more executed operations may be in real time or may have a set delay. Unless explicitly stated, there is no limitation on an order in which a plurality of operations is performed.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

Referring to FIG. 1, FIG. 1 is a schematic architectural diagram of a recommendation card presentation system according to an embodiment of this disclosure. To implement an application scenario of recommendation card presentation (for example, during driving, in response to a driver opening an application that supports recommendation card presentation on an in-vehicle terminal, such as a music playback client, at least two music recommendation cards in a clustered state are presented on a home page of the music playback client, that is, a view interface; where in the clustered state, the music recommendation cards are at initial positions, and a ratio of a first area to a second area is less than a first ratio; and the first area is a sum of areas of presented cards of the music recommendation cards, and the second area is a sum of card areas of the music recommendation cards; and a process of moving the music recommendation cards from the initial positions to target positions is displayed when the at least two music recommendation cards satisfy a separation condition, and the at least two music recommendation cards in a separated state are presented when the music recommendation cards are all at the target positions; in the separated state, the ratio of the first area to the second area being no less than a second ratio, and the second ratio being greater than the first ratio), a recommendation card display client 401 is disposed on a terminal (a terminal 400 is shown as an example), and is displayed on a display interface (an image interface 401-1 is shown as an example), and the terminal 400 is connected to a server 200 by using a network 300. The network 300 may be a wide area network, a local area network, or a combination thereof, which implements data transmission by using a wireless or wired link.

The server 200 is configured to transmit presentation data of at least two recommendation cards to the terminal 400 in response to a presentation data acquisition request of the at least two recommendation cards transmitted by the terminal.

The terminal 400 is further configured to present, in the view interface, the at least two recommendation cards in the clustered state based on the presentation data of the at least two recommendation cards, where the recommendation cards are configured to carry recommended content; in the clustered state, the recommendation cards being at initial positions, and a ratio of a first area to a second area being less than a first ratio; and the first area being a sum of presented card areas of the recommendation cards, and the second area being a sum of card areas of the recommendation cards; and display a process of moving the recommendation cards from the initial positions to target positions when the at least two recommendation cards satisfy a separation condition, and present the at least two recommendation cards in a separated state when the recommendation cards are all at the target positions; in the separated state, the ratio of the first area to the second area being no less than a second ratio, and the second ratio being greater than the first ratio.

In some embodiments, the server 200 may be an independent physical server, or may be a server cluster formed by a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The terminal 400 may be a smart phone, a tablet computer, a laptop, a desktop computer, a set-top box, an intelligent voice interaction device, a smart home appliance, a virtual reality device, an in-vehicle terminal, an aircraft, a portable music player, a personal digital assistant, a dedicated messaging device, a portable gaming device, a smart speaker, a smart watch, and the like, but is not limited thereto. The terminal and the server may be connected directly or indirectly in a wired or wireless communication manner, which is not limited in this embodiment of this disclosure.

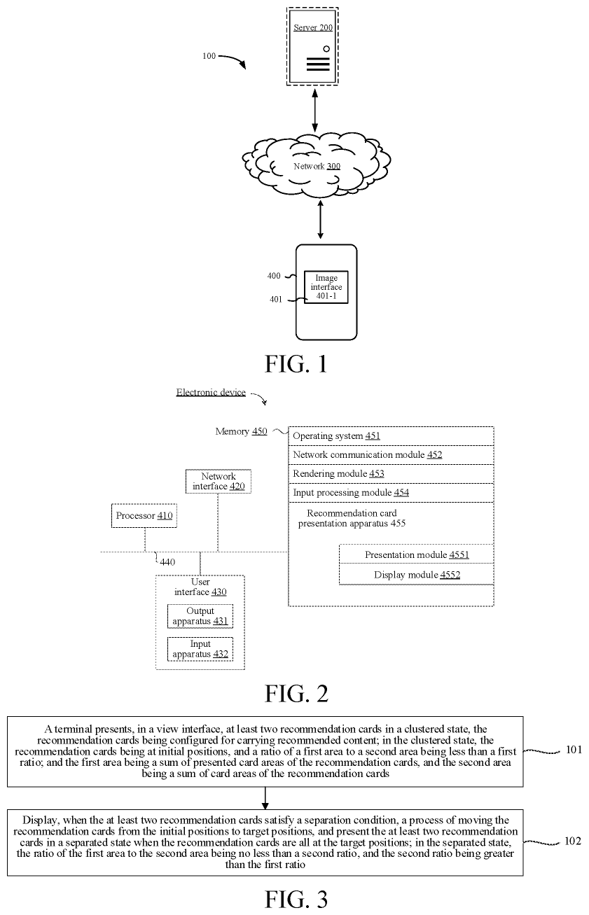

Next, an electronic device that implements the recommendation card presentation methods provided in the embodiments of this disclosure is described. Referring to FIG. 2, FIG. 2 is a schematic structural diagram of an electronic device according to an embodiment of this disclosure. The electronic device may be a server or a terminal. For example, the electronic device is the terminal shown in FIG. 1, and the electronic device shown in FIG. 2 includes: processing circuitry (e.g., at least one processor 410), a memory 450, at least one network interface 420, and a user interface 430. Components in the terminal 400 are coupled together by using a bus system 440. The bus system 440 is configured to implement connection and communication between the components. In addition to a data bus, the bus system 440 further includes a power bus, a control bus, and a state signal bus. However, for ease of clear description, all types of buses are marked as the bus system 440 in FIG. 3.

The processing circuitry (e.g., processor 410) may be an integrated circuit chip with a signal processing capability, such as a general-purpose processor, a digital signal processor (DSP), or another programmable logic device (PLD), discrete gate, transistor logic device, or discrete hardware component. The general-purpose processor may be a microprocessor, any related processor, or the like.

The user interface 430 includes one or more output apparatuses 431 that can display media content, which includes one or more loudspeakers and/or one or more visual display screens. The user interface 430 further includes one or more input apparatuses 432, which includes user interface members that help user input, such as a keyboard, a mouse, a microphone, a touch display screen, a camera, and other input buttons and controls.

The memory 450 may be a removable memory, an irremovable memory, or a combination thereof. Examples of hardware devices include a solid-state memory, a hard disk drive, an optical disk drive, and the like. In some embodiments, the memory 450 includes one or more storage devices physically located away from the processor 410.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in the embodiments of this disclosure is intended to include any suitable type of memories.

In some embodiments, the memory 450 can store data to support various operations. Examples of the data include a program, a module, and a data structure, or a subset or a superset thereof, which are described below as examples.

An operating system 451 includes system programs configured to process various basic system services and performing hardware-related tasks, such as a framework layer, a kernel library layer, and a driver layer, and is configured to implement various basic services and process hardware-based tasks.

A network communication module 452 is configured to reach another electronic device by using one or more (wired or wireless) network interfaces 420. As an example, the network interfaces 420 include: Bluetooth, Wi-Fi, a universal serial bus (USB), and the like.

A rendering module 453 is configured to enable display of information by using one or more output apparatuses 431 (for example, a display screen and a loudspeaker) associated with the user interface 430 (for example, a user interface configured to operate a peripheral device and display content and information).

An input processing module 454 is configured to detect one or more user inputs or interactions from the input apparatus 432 and translate a detected input or interaction.

In some embodiments, the apparatus provided in the embodiments of this disclosure may be implemented by software. FIG. 2 shows a recommendation card presentation apparatus 455 stored in a memory 450, which may be software in forms such as programs and plug-ins, and includes the following software modules: a presentation module 4551 and a display module 4552. The modules are logical and may be combined in different manners or further split according to implemented functions. Functions of the modules will be described below.

In some other embodiments, the apparatus provided in the embodiments of this disclosure may be implemented by hardware. As an example, the recommendation card presentation apparatus provided in the embodiments of this disclosure may be a processor in a form of a hardware decoding processor, programmed to perform the recommendation card presentation methods provided in the embodiments of this disclosure. For example, the processor in the form of the hardware decoding processor may use one or more application-specific integrated circuits (ASIC), a DSP, a programmable logic device (PLD), a complex programmable logic device (CPLD), a field-programmable gate array (FPGA), or other electronic components.

In some embodiments, the terminal or the server may implement the recommendation card presentation methods provided in the embodiments of this disclosure by running a computer program. For example, the computer program may be a native program or a software module in an operating system; may be a native application (APP), namely, a program that needs to be installed in the operating system to run, such as an instant messaging APP and a web page browser APP; or may be a mini program, namely, a program that only needs to be downloaded into a browser environment to run; or may be a mini program that can be embedded into any APP. In conclusion, the computer program may be any form of an application, a module, or a plug-in.

Based on the foregoing descriptions of the recommendation card presentation system and the electronic device provided in the embodiments of this disclosure, the recommendation card presentation methods provided in the embodiments of this disclosure is described below. In an example, the recommendation card presentation methods provided in the embodiments of this disclosure may be independently implemented by a terminal or a server, or may be collaboratively implemented by a terminal and a server. An example in which the terminal 400 in FIG. 1 independently performs the recommendation card presentation methods provided in the embodiments of this disclosure is used for description. Referring to FIG. 3, FIG. 3 is a schematic flowchart of a recommendation card display method according to an embodiment of this disclosure, which will be described with reference to operations shown in FIG. 3.

Operation 101: A terminal presents, in a view interface, at least two recommendation cards in a clustered state, the recommendation cards being configured to carry recommended content; in the clustered state, the recommendation cards being at initial positions, and a ratio of a first area to a second area being less than a first ratio; and the first area being a sum of presented card areas of the recommendation cards, and the second area being a sum of card areas of the recommendation cards. In an example, at least two recommendation cards are displayed in a view interface at initial positions in a clustered state. The at least two recommendation cards include recommended content. A ratio of a first area to a second area is less than a first ratio in the clustered state. The first area is a sum of visible areas of the at least two recommendation cards, and the second area is a sum of total areas of the at least two recommendation cards.

The terminal is provided with an application supporting presentation of the recommendation cards, such as a client. The client may be a music playback client, a video playback client, a social client, or the like. Correspondingly, the recommended content carried in the recommendation cards may be music content, such as recommended singers or recommended playlists, or may be video content, such as recommended movies or recommended variety shows, or may be image content, such as recommended images.

When a user opens an application on the terminal and the terminal runs the application, the terminal renders a view interface corresponding to the client. A recommendation control is displayed in the view interface, to display a recommendation interface in response to a trigger operation on the recommendation control. Therefore, a process of presenting, in a view interface, at least two recommendation cards in a clustered state may be presenting, in the recommendation interface of the view interface, the at least two recommendation cards in the clustered state.

For example, the terminal herein may be an in-vehicle terminal. When the terminal is an in-vehicle terminal, the user may be a driver, or another passenger in a vehicle in which the in-vehicle terminal is located, which is not limited in this embodiment of this disclosure. Based on this, in subsequent description, an operation performed by the user may be an operation performed by the driver in the vehicle in which the in-vehicle terminal is located, or an operation performed by another passenger in the vehicle in which the in-vehicle terminal is located, which is not limited in this embodiment of this disclosure.

During actual implementation, in the clustered state, the recommendation cards are at the initial positions. For a process of determining the initial positions of the recommendation cards, since display positions of the recommendation cards may be different for different dimensions of the recommendation interface, that is, the view interface, initial coordinates corresponding to the recommendation cards need to be determined based on an interface dimension of the recommendation interface, and then the initial positions of the recommendation cards are determined based on the initial coordinates corresponding to the recommendation cards. Based on this, the process of presenting, in a view interface, at least two recommendation cards in a clustered state may be: acquiring, when the view interface is a recommendation interface, an interface dimension of the recommendation interface, and determining, based on the interface dimension, values of change parameters corresponding to the recommendation cards; constructing an interface coordinate system corresponding to the recommendation interface, and acquiring coordinates of the recommendation cards in the interface coordinate system; adjusting, for the recommendation cards, the coordinates of the recommendation cards based on the values of the change parameters corresponding to the recommendation cards, to obtain initial coordinates of the recommendation cards in the interface coordinate system; and determining initial positions of the recommendation cards in the recommendation interface based on the initial coordinates of the recommendation cards in the interface coordinate system, and presenting the at least two recommendation cards in the clustered state at the initial positions of the recommendation interface.

Recommended content of different recommendation cards is different, sizes and dimensions of the different recommendation cards may also be different, and styles of the different recommendation cards may also be different, all of which may be preset. In addition, a quantity of the recommendation cards may also be preset. This is not limited in this embodiment of this disclosure.

The interface dimension of the recommendation interface may indicate a screen width corresponding to the recommendation interface, for example, less than 1440, 1440 to 2028, or greater than 2028. The coordinates of the recommendation cards may also be preset, so that the coordinates of the recommendation cards are adjusted based on the interface dimension of the recommendation interface, to obtain initial coordinates of the recommendation card in an interface coordinate system corresponding to the recommendation interface, thereby determining the initial position of each recommendation card in the recommendation interface.

During actual implementation, the interface dimension of the recommendation interface mostly falls within three dimension ranges, that is, a first dimension range (0, 1440), a second dimension range (1440, 2028), and a third dimension range (2028, ∞). For different dimension ranges, a process of adjusting the coordinates of the recommendation cards based on the interface dimension of the recommendation interface to obtain the initial coordinates of the recommendation cards in the interface coordinate system corresponding to the recommendation interface varies. Next, the process of adjusting the coordinates of the recommendation cards based on the interface dimension of the recommendation interface to obtain the initial coordinates of the recommendation cards in the interface coordinate system corresponding to the recommendation interface is separately described based on the three dimension ranges.

In some embodiments, after the interface dimension of the recommendation interface is acquired, a plurality of dimension ranges are acquired, and a target dimension range to which the interface dimension belongs is determined, so that a process of determining, based on the interface dimension, values of change parameters corresponding to the recommendation cards may be: acquiring a mapping relationship corresponding to the target dimension range; and substituting the interface dimension of the recommendation interface into the mapping relationship, to obtain the values of the change parameters corresponding to the recommendation cards. Specifically, when the interface dimension of the recommendation interface falls within the first dimension range of (0, 1440], a ratio of a difference among the interface dimension, a value of a first adjustment parameter, and a value a second adjustment parameter to a first parameter is acquired as a first dimension ratio, and a ratio of a difference among 1440, the value of the first adjustment parameter, and the value of the second adjustment parameter to the first parameter is acquired as a second dimension ratio; and a ratio of the first dimension ratio to the second dimension ratio is acquired as the value of the change parameter corresponding to each recommendation card. That is,

$$k = [ ( w - a - b ) / c ] / [ ( 1440 - a - b ) / c ] , \qquad Formula ( 1 )$$

where w denotes the interface dimension, that is, an interface width, a denotes the first adjustment parameter, which is a preset constant and is configured to indicate a sum of widths of idle regions in the recommendation interface, the idle regions are regions where no recommendation cards are presented, and the width indicates a dimension in a horizontal coordinate direction, b denotes the second adjustment parameter, which is a preset constant and is configured herein for adjusting magnitude of the change parameter corresponding to each recommendation card, and c denotes the first parameter, which may be 1, 2, or the like and is preset based on a ratio of a region occupied by the recommendation card to the recommendation interface. For example, when the region occupied by the recommendation card is half of the recommendation interface, the first parameter may be 2.

Then, an interface coordinate system corresponding to the recommendation interface is constructed, and coordinates of the recommendation cards are acquired; and for the recommendation cards, the coordinates of the recommendation cards are adjusted based on the values of the change parameters corresponding to the recommendation cards, to obtain initial coordinates of the recommendation cards in the interface coordinate system. The coordinates of each recommendation card are preset, which may be, for example, coordinates when the interface dimension is 1440. Therefore, a process of adjusting, for the recommendation cards, the coordinates of the recommendation cards based on the values of the change parameters corresponding to the recommendation cards, to obtain initial coordinates of the recommendation cards in the interface coordinate system may be: for each recommendation card, multiplying a horizontal coordinate of the recommendation card by the value of the change parameters based on the coordinates of the recommendation card, to obtain a first horizontal coordinate. That is,

$$x = {x}_{0} * k , \qquad Formula ( 2 )$$

where x₀ denotes a horizontal coordinate of the preset coordinates of the recommendation card.

Then, a difference between a vertical coordinate of the recommendation card and the value of the second adjustment parameter is calculated, to obtain a difference result, and the difference result is multiplied by the value of the change parameter, to obtain a multiplication result, so as to sum the multiplication result with the value of the second adjustment parameter, to obtain a first vertical coordinate. That is,

$$y = ( {y}_{0} - b ) * k + b , \qquad Formula ( 3 )$$

where y₀ denotes a vertical coordinate of the preset coordinates of the recommendation card, and b denotes the second adjustment parameter, which is a preset constant and is configured herein for adjusting magnitude of the vertical coordinate of the recommendation card.

Finally, initial coordinates of the recommendation card in the interface coordinate system are obtained based on the first horizontal coordinate and the first vertical coordinate.

In some embodiments, after the interface dimension of the recommendation interface is acquired, a plurality of dimension ranges are acquired, and a target dimension range to which the interface dimension belongs is determined, so that the process of determining, based on the interface dimension, values of change parameters corresponding to the recommendation cards may be: acquiring a mapping relationship corresponding to the target dimension range; and substituting the interface dimension of the recommendation interface into the mapping relationship, to obtain the values of the change parameters corresponding to the recommendation cards. Specifically, when the interface dimension of the recommendation interface falls within the second dimension range of (1440, 2028], a ratio of a difference among the interface dimension, the value of the first adjustment parameter, and the value of the second adjustment parameter to the first parameter is acquired as a third dimension ratio, and a ratio of a difference among 1440, the value of the first adjustment parameter, and the value of the second adjustment parameter to the first parameter is acquired as a fourth dimension ratio. A difference between the third dimension ratio and the fourth dimension ratio is calculated, to obtain a difference result, and a ratio of the difference result to the first parameter is acquired as the value of the change parameter corresponding to each recommendation card. That is,

$$k = [ ( w - a - b ) / c - ( 1440 - a - b ) / c ] / c , \qquad Formula ( 4 )$$

where w denotes the interface dimension, that is, an interface width, a denotes the first adjustment parameter, which is a preset constant and is configured to indicate a sum of widths of idle regions in the recommendation interface, the idle regions are regions where no recommendation cards are presented, and the width indicates a dimension in a horizontal coordinate direction, b denotes the second adjustment parameter, which is a preset constant and is configured herein for adjusting magnitude of the change parameter corresponding to each recommendation card, and c denotes the first parameter, which may be 1, 2, or the like and is preset based on a ratio of a region occupied by the recommendation card to the recommendation interface. For example, when the region occupied by the recommendation card is half of the recommendation interface, the first parameter may be 2.

Then, an interface coordinate system corresponding to the recommendation interface is constructed, and coordinates of the recommendation cards are acquired; and for the recommendation cards, the coordinates of the recommendation cards are adjusted based on the values of the change parameters corresponding to the recommendation cards, to obtain initial coordinates of the recommendation cards in the interface coordinate system. The coordinates of each recommendation card are preset, which may be, for example, coordinates when the interface dimension is 1440. Therefore, a process of adjusting, for the recommendation cards, the coordinates of the recommendation cards based on the values of the change parameters corresponding to the recommendation cards, to obtain initial coordinates of the recommendation cards in the interface coordinate system may be: for each recommendation card, summing a horizontal coordinate of the recommendation card with the value of the change parameter based on the coordinates of the recommendation card, to obtain a second horizontal coordinate. That is,

$$x = {x}_{0} + k , \qquad Formula ( 5 )$$

where x₀ denotes a horizontal coordinate of the preset coordinates of the recommendation card.

Next, a vertical coordinate of the recommendation card is maintained, that is, the vertical coordinate of the recommendation card is determined as a second vertical coordinate, so as to obtain the initial coordinates of the recommendation card in the interface coordinate system based on the second horizontal coordinate and the second vertical coordinate.

In some other embodiments, after the interface dimension of the recommendation interface is acquired, a plurality of dimension ranges are acquired, and a target dimension range to which the interface dimension belongs is determined, so that a process of determining, based on the interface dimension, values of change parameters corresponding to the recommendation cards may be: acquiring a mapping relationship corresponding to the target dimension range; and substituting the interface dimension of the recommendation interface into the mapping relationship, to obtain the values of the change parameters corresponding to the recommendation cards. Specifically, when the interface dimension of the recommendation interface falls within the third dimension range of (2028, ∞), a ratio of a difference among the interface dimension, the value of the first adjustment parameter, and the value of the second adjustment parameter to the first parameter is acquired as a fifth dimension ratio, and a ratio of a difference among 2028, the value of the first adjustment parameter, and the value of the second adjustment parameter to the first parameter is acquired as a sixth dimension ratio. A ratio of the fifth dimension ratio to the sixth dimension ratio is acquired as the value of the change parameter corresponding to each recommendation card. That is,

$$k = [ ( w - a - b ) / c ] / [ ( 2028 - a - b ) / c ] , \qquad Formula ( 6 )$$

where w denotes the interface dimension, that is, an interface width, a denotes the first adjustment parameter, which is a preset constant and is configured to indicate a sum of widths of idle regions in the recommendation interface, the idle regions are regions where no recommendation cards are presented, and the width indicates a dimension in a horizontal coordinate direction, b denotes the second adjustment parameter, which is a preset constant and is configured herein for adjusting magnitude of the change parameter corresponding to each recommendation card, and c denotes the first parameter, which may be 1, 2, or the like and is preset based on a ratio of a region occupied by the recommendation card to the recommendation interface. For example, when the region occupied by the recommendation card is half of the recommendation interface, the first parameter may be 2.

Then, an interface coordinate system corresponding to the recommendation interface is constructed, and coordinates of the recommendation cards are acquired; and for the recommendation cards, the coordinates of the recommendation cards are adjusted based on the values of the change parameters corresponding to the recommendation cards, to obtain initial coordinates of the recommendation cards in the interface coordinate system. The coordinates of each recommendation card are preset, which may be, for example, coordinates when the interface dimension is 2028. Therefore, a process of adjusting, for the recommendation cards, the coordinates of the recommendation cards based on the values of the change parameters corresponding to the recommendation cards, to obtain initial coordinates of the recommendation cards in the interface coordinate system may be: for each recommendation card, multiplying a horizontal coordinate of the recommendation card by the value of the change parameter based on the coordinates of the recommendation card, to obtain a third horizontal coordinate. That is,

$$x = {x}_{0} * k , \qquad Formula ( 7 )$$

where x₀ denotes a horizontal coordinate of the preset coordinates of the recommendation card.

Then, a difference between a vertical coordinate of the recommendation card and the value of the second adjustment parameter is calculated, to obtain a difference result, and the difference result is multiplied by the value of the change parameter, to obtain a multiplication result, so as to sum the multiplication result with the value of the second adjustment parameter, to obtain a third vertical coordinate. That is,

$$y = ( {y}_{0} - b ) * k + b , \qquad Formula ( 8 )$$

where y₀ denotes a vertical coordinate of the preset coordinates of the recommendation card, and b denotes the second adjustment parameter, which is a preset constant and is configured herein for adjusting magnitude of the vertical coordinate of the recommendation card.

Finally, the initial coordinates of the recommendation card in the interface coordinate system are obtained based on the third horizontal coordinate and the third vertical coordinate.

When the interface dimension of the recommendation interface falls within the third dimension range of (2028, ∞), x₀ and y₀ in Formula (7) and Formula (8) may not be the horizontal coordinate and the vertical coordinate of the preset coordinates of the recommendation card, but be an intermediate horizontal coordinate and an intermediate vertical coordinate that are determined based on the horizontal coordinate and the vertical coordinate of the preset coordinates of the recommendation card. Specifically, a ratio of a difference among 2028, the value of the first adjustment parameter, and the value of the second adjustment parameter to the first parameter is acquired as a first intermediate dimension ratio, and a ratio of a difference among 1440, the value of the first adjustment parameter, and the value of the second adjustment parameter to the first parameter is acquired as a second intermediate dimension ratio; and a difference between the first intermediate dimension ratio and the second intermediate dimension ratio is calculated, to obtain a difference result, and a ratio of the difference result to the first parameter is acquired as a value of an intermediate change parameter corresponding to each recommendation card. That is,

$${k}^{′} = [ ( 2028 - a - b ) / c - ( 1440 - a - b ) / c ] / c , \qquad Formula ( 9 )$$

where a denotes the first adjustment parameter, which is a preset constant and is configured to indicate a sum of widths of idle regions in the recommendation interface, the idle regions are regions where no recommendation cards are presented, b denotes the second adjustment parameter, which is a preset constant and is configured herein for adjusting magnitude of the intermediate change parameter corresponding to each recommendation card, and c denotes the first parameter, which may be 1, 2, or the like and is preset based on a ratio of a region occupied by the recommendation card to the recommendation interface. For example, when the region occupied by the recommendation card is half of the recommendation interface, the first parameter may be 2.

Then, for each recommendation card, the horizontal coordinate of the recommendation card is summed with the value of the intermediate change parameter based on the coordinates of the recommendation card, to obtain an intermediate horizontal coordinate. That is,

$${x}^{′} = {x}_{0} + {k}^{′} , \qquad Formula ( 10 )$$

where x₀ denotes a horizontal coordinate of the preset coordinates of the recommendation card.

Then, a vertical coordinate of the recommendation card is maintained. To be specific, the vertical coordinate of the recommendation card is determined as an intermediate vertical coordinate, so as to substitute the intermediate horizontal coordinate and the intermediate vertical coordinate into Formula (7) and Formula (8), to determine the third horizontal coordinate and the third vertical coordinate. In this way, compared with that the third horizontal coordinate and the third vertical coordinate are directly determined based on the preset coordinates, the third horizontal coordinate and the third vertical coordinate are determined by using the intermediate vertical coordinate and the intermediate horizontal coordinate, so as to obtain the initial coordinates of the recommendation card in the interface coordinate system based on the third horizontal coordinate and the third vertical coordinate, which can enhance a widened display effect of the recommendation card on the recommendation interface when the interface dimension of the recommendation interface is relatively large, for example, falls within the dimension range of (2028, ∞).

By applying the foregoing embodiments, due to a variety of interface dimensions of the recommendation interface, for different interface dimensions, the coordinates of the recommendation card are dynamically adjusted, which ensures adaptability of presentation of the recommendation card in interfaces of different dimensions and enhances a presentation effect of the recommendation card.

During actual implementation, in addition to adjusting the coordinates of the recommendation card based on the interface dimension of the recommendation interface, presentation dimensions of the recommendation card may also be adjusted based on the interface dimension of the recommendation interface. Specifically, a process of presenting, in a view interface, at least two recommendation cards in a clustered state may be: acquiring, when the view interface is a recommendation interface, an interface dimension of the recommendation interface, and determining the values of the change parameters corresponding to the recommendation cards based on the interface dimension; acquiring initial dimensions of the recommendation cards, and adjusting, for the recommendation cards, the initial dimensions of the recommendation cards based on the values of the change parameters corresponding to the recommendation cards, to obtain target dimensions of the recommendation cards, the target dimensions being configured to indicate card presentation dimensions matching the interface dimension of the recommendation interface; and presenting, in the recommendation interface, the at least two recommendation cards in the clustered state based on the target dimensions of the recommendation cards.

As described above, the interface dimension of the recommendation interface mostly falls within three dimension ranges, that is, a first dimension range (0, 1440], a second dimension range (1440, 2028], and a third dimension range (2028, ∞). For different dimension ranges, a process of adjusting the coordinates of the recommendation cards based on the interface dimension of the recommendation interface to obtain the initial coordinates of the recommendation cards in the interface coordinate system corresponding to the recommendation interface varies. Correspondingly, for the different dimension ranges, the process of adjusting the initial dimensions of the recommendation cards based on the interface dimension of the recommendation interface to obtain the target dimensions of the recommendation cards also varies. Next, the process of adjusting the initial dimensions of the recommendation cards based on the interface dimension of the recommendation interface, to obtain the target dimensions of the recommendation cards is separately described based on the three dimension ranges.

In some embodiments, when the interface dimension of the recommendation interface falls within the dimension range of (0, 1440], a process of determining the values of the change parameters corresponding to the recommendation cards based on the interface dimension may be: acquiring a ratio of a difference among the interface dimension, the value of the first adjustment parameter, and the value of the second adjustment parameter to the first parameter as a first dimension ratio, acquiring a ratio of a difference among 1440, the value of the first adjustment parameter, and the value of the second adjustment parameter to the first parameter as a second dimension ratio; and acquiring a ratio of the first dimension ratio to the second dimension ratio as the value of the change parameter corresponding to each recommendation card, as shown in Formula (1).

Then, initial dimensions of each recommendation card are acquired. The initial dimensions of the recommendation card include a width of the recommendation card, that is, a dimension in a horizontal coordinate direction, and a length of the recommendation card, that is, a dimension in a vertical coordinate direction. Herein, the initial dimensions of the recommendation card may be preset.

Next, the process of adjusting, for the recommendation cards, the initial dimensions of the recommendation cards based on the values of the change parameters corresponding to the recommendation cards, to obtain target dimensions of the recommendation cards may be: multiplying, for each recommendation card, the width of the recommendation card, that is, the dimension in the horizontal coordinate direction, by the value of the change parameter based on the dimensions of the recommendation card, to obtain a first width. That is,

$$width = {width}_{0} * k , \qquad Formula ( 11 )$$

where width₀ denotes a preset width of the recommendation card, that is, the dimension in the horizontal coordinate direction.

Moreover, the length of the recommendation card, that is, the dimension in the vertical coordinate direction, is multiplied by the value of the change parameter, to obtain a first length. That is,

$$height = {height}_{0} * k , \qquad Formula ( 12 )$$

where height₀ denotes a preset length of the recommendation card, that is, the dimension in a vertical coordinate direction.

Finally, the target dimensions of the recommendation card are obtained based on the first length and the first width.

In some embodiments, when the interface dimension of the recommendation interface falls within the dimension range of (1440, 2028], the target dimensions of the recommendation card are the same as the initial dimensions of the recommendation card, which includes that the initial dimensions of the recommendation card remain unchanged, that is, the initial dimensions of the recommendation card are determined as the target dimensions of the recommendation card.

In some other embodiments, when the interface dimension of the recommendation interface falls within the dimension range of (2028, ∞), a process of determining the values of the change parameters corresponding to the recommendation cards based on the interface dimension may be: acquiring a ratio of a difference among the interface dimension, the value of the first adjustment parameter, and the value of the second adjustment parameter to the first parameter as a fifth dimension ratio, and acquiring a ratio of a difference among 2028, the value of the first adjustment parameter, the value of the second adjustment parameter to the first parameter as a sixth dimension ratio; and acquiring a ratio of the fifth dimension ratio to the sixth dimension ratio as the value of the change parameter corresponding to each recommendation card, as shown in Formula (6).

Then, initial dimensions of each recommendation card are acquired. The initial dimensions of the recommendation card include a width of the recommendation card, that is, a dimension in a horizontal coordinate direction, and a length of the recommendation card, that is, a dimension in a vertical coordinate direction. Herein, the initial dimensions of the recommendation card may be preset.

Next, for each recommendation card, the width of the recommendation card, that is, the dimension in the horizontal coordinate direction, is multiplied by the value of the change parameter based on the initial dimensions of the recommendation card, to obtain a second width, as shown in Formula (11). Then, the length of the recommendation card, that is, the dimension in the vertical coordinate direction, is multiplied by the value of the change parameter, to obtain a second length, as shown in Formula (12). Finally, the target dimensions of the recommendation card are obtained based on the second length and the second width.

In this way, the coordinates and the dimensions of the recommendation card are dynamically adjusted based on different screen widths, that is, widths of the recommendation interface, which ensures adaptability of presentation of the recommendation card in interfaces of different dimensions, thereby enhancing a presentation effect of the recommendation card.

During actual implementation, as described above, in the clustered state, the recommendation cards are at the initial positions, and the ratio of the first area to the second area is less than the first ratio. The first area is a sum of presented card areas of the recommendation cards, and the second area is a sum of card areas of the recommendation cards.

A process of determining the second area may be: acquiring the card areas of the recommendation cards, and summing the card areas of the recommendation cards, to obtain the sum of the card areas of the recommendation cards, that is, the second area. A process of determining the first area may be: in the clustered state, acquiring presented card areas of the recommendation cards, and summing the presented card areas of the recommendation cards, to obtain the sum of the presented card areas of the recommendation cards, that is, the first area.

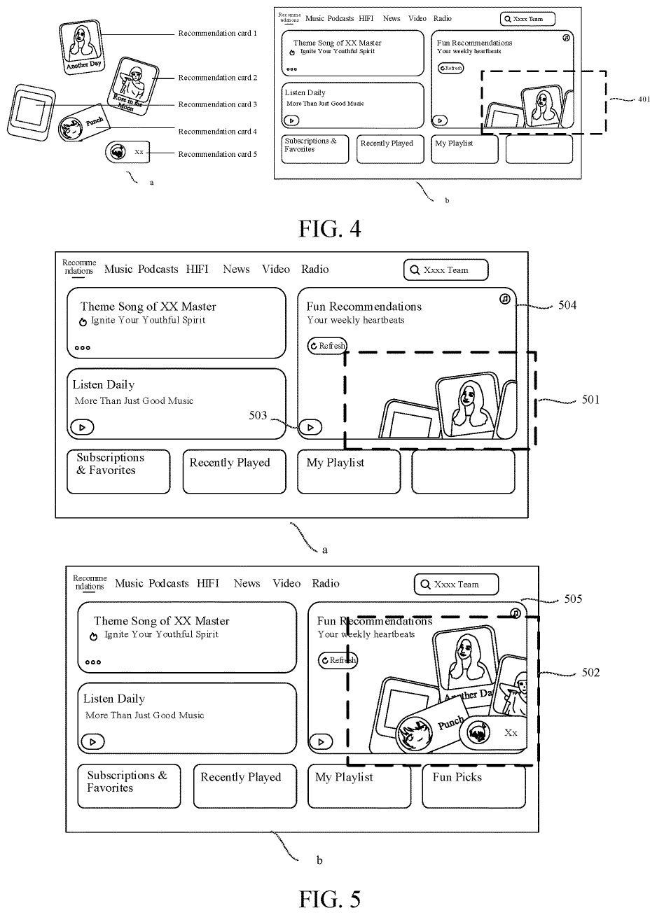

For example, referring to FIG. 4, FIG. 4 is a schematic diagram of a first area and a second area according to an embodiment of this disclosure. Based on FIG. 4, a sum of areas of five recommendation cards in a is the second area, and a dashed box 401 in b indicates three recommendation cards presented in a clustered state, so that a sum of presented card areas of the three recommendation cards is the first area.

Operation 102: Display, when the at least two recommendation cards satisfy a separation condition, a process of moving the recommendation cards from the initial positions to target positions, and present the at least two recommendation cards in a separated state when the recommendation cards are all at the target positions; in the separated state, the ratio of the first area to the second area being no less than a second ratio, and the second ratio being greater than the first ratio. In an example, when the at least two recommendation cards satisfy a separation condition, the at least two recommendation cards are controlled to move from the initial positions to target positions. The at least two recommendation cards are displayed in a separated state when the at least two recommendation cards are at the target positions. In the separated state, the ratio of the first area to the second area is not less than a second ratio. The second ratio is greater than the first ratio.

The first ratio and the second ratio herein are both preset.

During actual implementation, whether the at least two recommendation cards satisfy the separation condition may be determined in a variety of manners, which, for example, may be determined by using a duration or may be determined by using an operation of the user. Next, three determination manners are used as examples, to describe a process of determining whether the at least two recommendation cards satisfy the separation condition.

In some embodiments, after the at least two recommendation cards in the clustered state are presented, a first presentation duration of the at least two recommendation cards in the clustered state may be displayed. When the first presentation duration reaches a target first presentation duration, it is determined that at least two recommendation cards satisfy the separation condition.

The target first presentation duration herein may be preset, for example, 2 s. After the at least two recommendation cards in the clustered state are presented, the first presentation duration of the at least two recommendation cards in the clustered state is detected in real time. When a detection result represents that the first presentation duration reaches the target first presentation duration, it is determined that the at least two recommendation cards satisfy the separation condition.

In some embodiments, after the at least two recommendation cards in the clustered state are presented, a slide trajectory of a slide operation may be further displayed in response to the slide operation triggered in the view interface; and when the slide trajectory matches a target slide trajectory, it is determined that the at least two recommendation cards satisfy the separation condition.

When a slide operation triggered by the user in the view interface is received, a slide trajectory of the slide operation is compared with the target slide trajectory, and when a comparison result is that a standard slide trajectory of the slide operation is consistent with the target slide trajectory, it is determined that the at least two recommendation cards satisfy the separation condition. The target slide trajectory may be preset.

During actual implementation, after the at least two recommendation cards in the clustered state are presented, sliding guidance information may be displayed. The sliding guidance information may be in a text form, or may be in an animation form, and is configured to indicate the target slide trajectory, so that the slide trajectory of the slide operation is displayed based on the sliding guidance information in response to the slide operation triggered in the view interface.

In some other embodiments, after the at least two recommendation cards in the clustered state are presented, an interactive element may further be displayed; and it is determined, in response to a card separation operation triggered based on the interactive element, that the at least two recommendation cards satisfy the separation condition.

A form of the interactive element may be preset, and the card separation operation triggered based on the interactive element is related to the form of the interactive element. For example, when the interactive element is a virtual fruit, the card separation operation may be a slicing operation on the virtual fruit.

In this way, it is determined in different manners that the at least two recommendation cards satisfy the separation condition, which enriches diversity of manners in which the separation condition is satisfied, thereby improving human-computer interaction efficiency and utilization of hardware processing resources.

In some embodiments, the displaying, when the at least two recommendation cards satisfy a separation condition, a process of moving the recommendation cards from the initial positions to target positions may be: controlling, when the at least two recommendation cards satisfy the separation condition, each of the recommendation cards to break into a plurality of card fragments; and displaying a process of moving the card fragments of each of the recommendation cards from initial positions to target positions.

Quantities of the card fragments corresponding to the recommendation cards herein may be the same or different.

During actual implementation, after the displaying a process of moving the card fragments of each of the recommendation cards from initial positions to target positions, a process of combining the card fragments of each recommendation card to form a complete card may be displayed when the card fragments of the recommendation card are at the target positions.

It is determined that each recommendation card is at the target position only after the card fragments of all the recommendation cards are combined to form complete cards. That is, when the card fragments of each recommendation card are at the target positions, it is not considered that each recommendation card is at the target position.

By applying the foregoing embodiments, the recommendation cards are respectively broken into a plurality of card fragments, and then when the card fragments of each recommendation card are at the target positions, the card fragments of each recommendation card are combined and a formed complete card is displayed. In this way, diversity of a moving process of the recommendation card and resource utilization of the recommendation card are improved.

In some embodiments, the clustered state is obtained by presenting the at least two recommendation cards in a superimposing manner, so that the displaying, when the at least two recommendation cards satisfy a separation condition, a process of moving the recommendation cards from the initial positions to target positions may be displaying, when the at least two recommendation cards satisfy the separation condition, starting from the topmost recommendation card and based on a superimposing sequence of the at least two recommendation cards presented in a superimposing manner, a process of sequentially moving the recommendation cards from the initial positions to the target positions, moving speeds of the recommendation cards being inversely proportional to recommendation degrees of the corresponding recommendation cards.

The displaying, starting from the topmost recommendation card, a process of sequentially moving the recommendation cards from the initial positions to the target positions may be that after a current recommendation card is moved to the target position, next recommendation card is then moved from the initial position to the target position, or may be that after the current recommendation card is moved from the initial position, and during the movement to the target position, the next recommendation card starts to move from the initial position. For example, upon expiration of a target duration such as 0.5 s or 1 s, after the current recommendation card is moved from the initial position, the next recommendation card starts to move from the initial position. This is not limited in this embodiment of this disclosure.

A recommendation degree of the recommendation card is determined by using historical behavior data of the user. Specifically, the historical behavior data of the user is acquired, and matching is performed with a plurality of pieces of recommended content in a database based on the historical behavior data of the user; and matching degrees of matching results are taken as recommendation degrees of the corresponding recommended content. That is, a higher matching degree of a matching result indicates a higher recommendation degree of a recommendation card corresponding to corresponding recommended content. Correspondingly, the at least two recommendation cards are also determined by using matching results. Specifically, after matching is performed with the plurality of recommended content in the database based on the historical behavior data of the user, the plurality of matching results are sorted based on the matching degrees, and starting from the matching result with the highest matching degree, a target quantity of matching results are selected as target matching results; and recommended content corresponding to the target matching results is taken as recommended content to be recommended to the user. That is, recommended content carried in the at least two recommendation cards presented is the recommended content corresponding to the target matching results.

By applying the foregoing embodiments, a higher recommendation degree of the recommendation card indicates a slower moving speed of the recommendation card, and a lower recommendation degree of the recommendation card indicates a higher moving speed of the recommendation card. In this way, diversity of the presentation process of the recommendation card is improved, and user experience is also improved.

In some embodiments, the displaying, when the at least two recommendation cards satisfy a separation condition, a process of moving the recommendation cards from the initial positions to target positions may alternatively be: displaying, when the at least two recommendation cards satisfy the separation condition, moving trajectories of the recommendation cards in the view interface, the moving trajectories being in a special effect display state; and displaying a process of moving the recommendation cards from the initial positions to the target positions along the corresponding moving trajectories.

The special effect display state herein is configured to indicate that the moving trajectory is displayed in a form of a special effect such as a halo or highlighting. In this way, moving processes of the recommendation cards are presented by using the moving trajectories displayed using special effects, which improves diversity of a presentation process of the recommendation cards and a presentation effect of the recommendation cards.

In some embodiments, the recommendation cards are located in a card recommendation region of the view interface, so that the displaying, when the at least two recommendation cards satisfy a separation condition, a process of moving the recommendation cards from the initial positions to target positions may alternatively be: controlling, when the at least two recommendation cards satisfy the separation condition, the card recommendation region to be displayed in a tilted manner in the view interface; and controlling, during the tilted display of the card recommendation region, the recommendation cards to move from the initial positions to a boundary of the view interface along a tilt direction of the card recommendation region, and controlling, when the recommendation cards move to the boundary of the view interface, the corresponding recommendation cards to move to the target positions.

The titled display of the card recommendation region in the view interface may be leftward tilted display or rightward tilted display. Therefore, when the titled display of the card recommendation region in the view interface is leftward tilted display, the recommendation cards are sequentially moved leftwards from the initial positions to the boundary of the view interface. When the titled display of the card recommendation region in the view interface is rightward tilted display, the recommendation cards are sequentially moved rightwards from the initial positions to the boundary of the view interface. This is not limited in the embodiments of this disclosure. Meanwhile, when the recommendation cards are controlled to move sequentially from the initial positions to the boundary of the view interface, the moving speeds of the recommendation cards may be the same or different. For example, the moving speeds of the recommendation cards are inversely proportional or positively proportional to recommendation degrees of the corresponding recommendation cards. In addition, when each recommendation card moves to the boundary of the view interface, that is, when each recommendation card touches the boundary of the view interface, the corresponding recommendation card is controlled to bounce back to the target position.

During actual implementation, referring to FIG. 5, FIG. 5 is a schematic diagram of initial positions and target positions of recommendation cards according to an embodiment of this disclosure. Based on FIG. 5, a dashed box 501 in a indicates five recommendation cards in a clustered state that are displayed at the initial positions, and a dashed box 502 in b indicates five recommendation cards in a separated state that are displayed at the target positions, where 504 in a and 505 in b indicate card recommendation regions in a view interface. That is, when the five recommendation cards in the clustered state indicated by the dashed box 501 in a satisfy the separation condition, a process of moving the recommendation cards from the initial positions as indicated by the dashed box 501 in a to the target positions indicated by the dashed box 502 in b is displayed, so that the five recommendation cards in the separated state as indicated by the dashed box 502 in b are displayed.

During the movement of the recommendation cards from the initial positions to the target positions, the recommendation cards may alternatively be rotationally moved, or may be normally moved, that is, non-rotationally moved, which is not limited in this embodiment of this disclosure.

During actual application, when the card recommendation region is displayed in a tilted manner, the recommendation cards also move along a tilt direction of the card recommendation region. In this way, diversity of a presentation process of the recommendation cards is improved, and a presentation effect of the recommendation cards is also improved.

During actual implementation, a process of determining target positions of the recommendation cards in the recommendation interface may be acquiring values of coordinate adjustment parameters corresponding to the recommendation cards; adjusting, for the recommendation cards, the initial coordinates of the recommendation cards based on the values of the coordinate adjustment parameters corresponding to the recommendation cards, to obtain target coordinates of the recommendation cards in the interface coordinate system; and determining the target positions of the recommendation cards in the recommendation interface based on the target coordinates of the recommendation cards in the interface coordinate system.

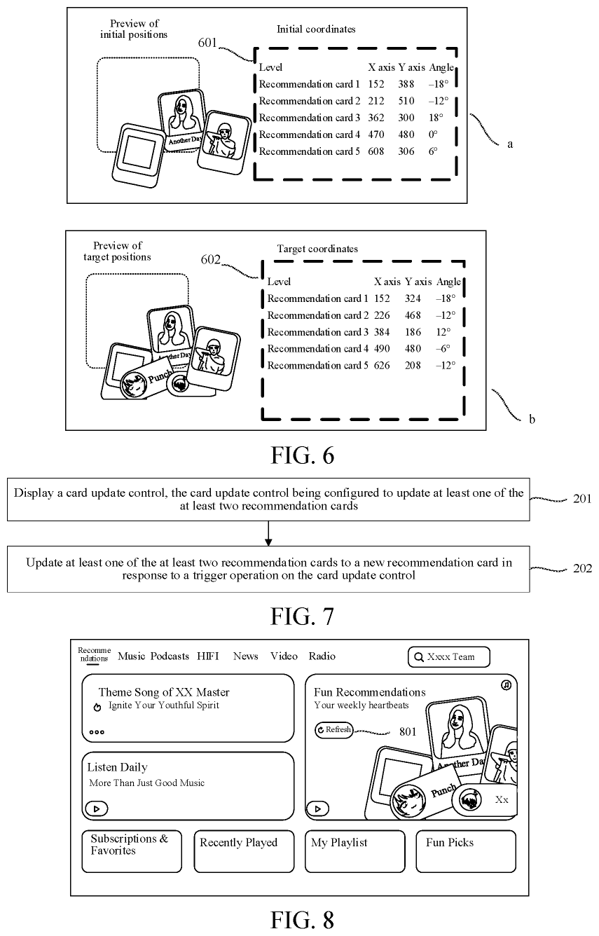

As described above, the interface coordinate system may be pre-constructed, and the initial coordinates of the recommendation cards are also determined as described above. Moreover, the coordinate adjustment parameters corresponding to each recommendation card include Δx and Δy, and the values of the coordinate adjustment parameters may be preset. For example, referring to FIG. 6, FIG. 6 is a schematic diagram of initial coordinates and target coordinates of recommendation cards according to an embodiment of this disclosure. Based on FIG. 6, a indicates the initial coordinates of the recommendation cards, a dashed box 601 in a indicates values of horizontal coordinates and values of vertical coordinates of the initial coordinates of the recommendation cards, b indicates the target coordinates of the recommendation cards, and dashed box 602 in b indicates values of horizontal coordinates and values of vertical coordinates of the target coordinates of the recommendation cards. Taking a recommendation card 1 and a recommendation card 2 as examples, initial coordinates of the recommendation card 1 are (152, 388), and corresponding coordinate adjustment parameters are Δx=0 and Δy=−64, so that the initial coordinates (152, 388) of the recommendation card 1 are adjusted based on the values of the coordinate adjustment parameters corresponding to the recommendation card 1, to obtain target coordinates (152, 324) of the recommendation card in the interface coordinate system. Initial coordinates of the recommendation card 2 are (212, 510), and corresponding coordinate adjustment parameters are Δx=14 and Δy=−42, so that the initial coordinates (212, 510) of the recommendation card 2 are adjusted based on the values of the coordinate adjustment parameters corresponding to the recommendation card 2, to obtain target coordinates (226, 468) of the recommendation card in the interface coordinate system.

By applying the foregoing embodiments, the target coordinates of the recommendation cards are determined based on preset coordinate adjustment parameters, thereby achieving position transformation of the recommendation cards, which makes position transformation processes of the recommendation cards more regular and also improves efficiency and accuracy of determination of the target positions of the recommendation cards.

In some embodiments, the clustered state is obtained by presenting the at least two recommendation cards in a superimposing manner, so that the process of presenting the at least two recommendation cards in the separated state when the recommendation cards are at the target positions may be: presenting, when the recommendation cards are at the target positions, the topmost target recommendation card in an enlarged manner based on a superimposing sequence of the at least two recommendation cards presented in a superimposing manner, and displaying a second presentation duration of the target recommendation card; and controlling, when the second presentation duration reaches a target second presentation duration, the target recommendation card to restore to an original presentation size, and displaying the target recommendation card and another recommendation card in a separated state, the original presentation size being configured to indicate a presentation size of the target recommendation card before the enlarged presentation, and the another recommendation card being configured to indicate a recommendation card of the at least two recommendation cards other than the target recommendation card.

The target second presentation duration may be preset, for example, 0.5 s or 1 s, and an enlarged dimension may also be preset. Meanwhile, the enlarged presentation herein may be enlarging a dimension of the target recommendation card, but the recommended content carried in the target recommendation card is not displayed, or may be enlarging the dimension of the target recommendation card, so that the recommended content carried in the target recommendation card is previewed and presented by using the enlarged target recommendation card. This is not limited in this embodiment of this disclosure.

Herein, the topmost target recommendation card may be presented in an enlarged manner, or the recommendation cards may be presented sequentially in an enlarged manner starting from the topmost target recommendation card based on a superimposing sequence of the at least two recommendation cards presented in a superimposing manner. After a previous recommendation card is restored to an original presentation size, next recommendation card may be presented in an enlarged manner, or during the enlarged display of the previous recommendation card, the next recommendation card may be enlarged and overlaid on the previous recommendation card, to present the next enlarged recommendation card. This is not limited in this embodiment of this disclosure.

By applying the foregoing embodiments, the target recommendation card may be presented in an enlarged manner, and when the second presentation duration of the target recommendation card reaches the target second presentation duration, the size of the target recommendation card is restored, and the target recommendation card and another recommendation card are displayed. In this way, diversity of a presentation process of the recommendation cards is improved, user experience is improved, and a presentation effect of the recommendation cards is also improved.

In some embodiments, after the at least two recommendation cards in the separated state are presented when the recommendation cards are all at the target positions, the recommendation cards may further be updated. Referring to FIG. 7, FIG. 7 is a schematic flowchart of a recommendation card update process according to an embodiment of this disclosure. Based on FIG. 7, the recommendation card update process may be implemented by using the following operations.

Operation 201: Display a card update control, the card update control being configured to update at least one of at least two recommendation cards.

A quantity of recommendation cards in the at least two recommendation cards used by the card update control for update may be preset, which may be one recommendation card or may be all the recommendation cards. This is not limited in this embodiment of this disclosure.

For example, referring to FIG. 8, FIG. 8 is a schematic diagram of a card update control according to an embodiment of this disclosure. Based on FIG. 8, a control indicated by 801 is a card update control, configured to update at least one of the at least two recommendation cards.

Operation 202: Update at least one of the at least two recommendation cards to a new recommendation card in response to a trigger operation on the card update control.

In some embodiments, when the card update control is configured to update a target quantity of recommendation cards and the target quantity is less than a quantity of the recommendation cards, a process of updating at least one of the at least two recommendation cards to a new recommendation card in response to a trigger operation on the card update control may be: updating the target quantity of recommendation cards to new recommendation cards in response to the trigger operation on the card update control.

As described above, the at least two recommendation cards are determined according to matching results obtained by matching the historical behavior data of the user with the plurality of pieces of recommended content in the database. Based on this, the target quantity of recommendation cards herein may be a recommendation card of the at least two recommendation cards which includes recommended content corresponding to the matching result with the lowest matching degree. Specifically, matching degrees corresponding to recommended content of the recommendation cards are acquired in response to the trigger operation on the card update control; the recommendation cards are sorted based on the matching degrees, and a target quantity of recommendation cards are selected starting from the recommendation card corresponding to the recommended content with the lowest matching degree; and the selected target quantity of recommendation cards are updated to new recommendation cards. Alternatively, herein, the target quantity of recommendation cards may be selected starting from the recommendation card corresponding to recommended content with the highest matching degree; and the selected target quantity of recommendation cards are updated to new recommendation cards. This is not limited in this embodiment of this disclosure.

In some other embodiments, when the card update control is configured to update all the recommendation cards, a process of updating at least one of the at least two recommendation cards to a new recommendation card in response to a trigger operation on the card update control may be directly updating the at least two recommendation cards to at least two new recommendation cards in response to the trigger operation on the card update control, or displaying a process of moving the recommendation cards from the target positions to the initial positions in response to the trigger operation on the card update control; and updating the recommendation cards to new recommendation cards respectively when the recommendation cards are all at the initial positions.

When the card update control is configured to update all the recommendation cards, in response to the trigger operation on the card update control, the recommendation cards may alternatively be collapsed, that is, converted from the separated state to the clustered state, that is, the process of moving the recommendation cards from the target positions to the initial positions is displayed, so that the recommendation cards are respectively updated to new recommendation cards when the recommendation cards are all at the initial positions.

Herein, the displaying a process of moving the recommendation cards from the target positions to the initial positions, as described above, may alternatively be controlling each of the recommendation cards to separately break into a plurality of card fragments; displaying a process of moving the card fragments of each of the recommendation cards from the target positions to the initial positions; and displaying, when the card fragments of each recommendation card are at the initial positions, a process of combining the card fragments of each recommendation card to form a complete card, and updating the recommendation card to a new recommendation card. Alternatively, the clustered state may be obtained by presenting the at least two recommendation cards in a superimposing manner, so that the process of sequentially moving, starting from the topmost recommendation card, the recommendation cards from the target positions to the initial positions is displayed based on a superimposing sequence of the at least two recommendation cards presented in a superimposing manner. Moving speeds of the recommendation cards are inversely proportional to recommendation degrees of the corresponding recommendation cards.

The manner of displaying the process of moving the recommendation cards from the target positions to the initial positions includes, but is not limited to, the foregoing two manners. This is not limited in this embodiment of this disclosure.

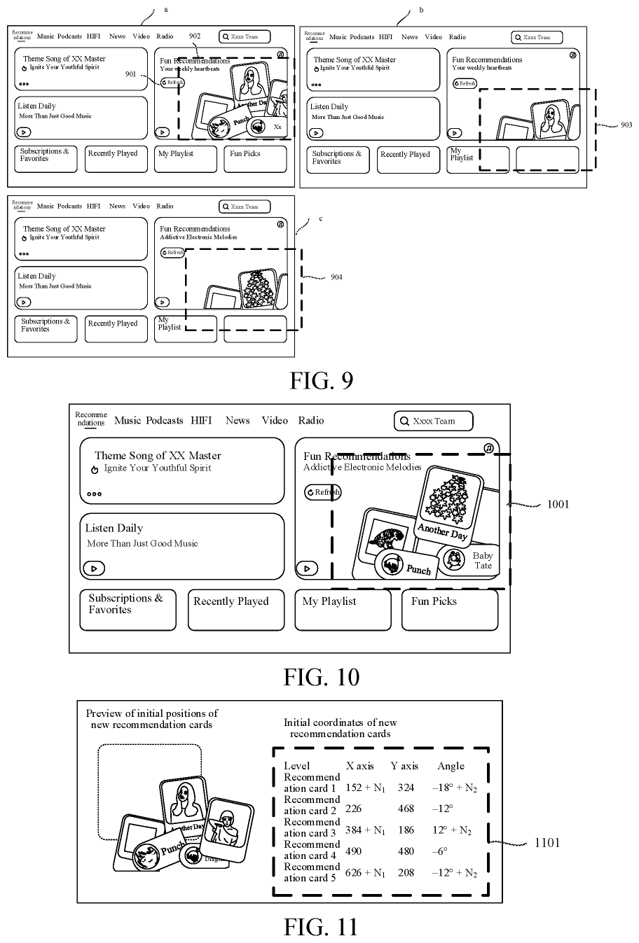

For example, referring to FIG. 9, FIG. 9 is a schematic diagram of a process of respectively updating recommendation cards to new recommendation cards according to an embodiment of this disclosure. Based on FIG. 9, in response to a trigger operation on a card update control indicated by 901 in a, a process of moving the recommendation cards in a dashed box 902 from target positions to initial positions is displayed, so as to display recommendation cards indicated by a dashed box 903 in b, so that the recommendation cards are respectively updated to new recommendation cards when the recommendation cards are all at the initial positions, that is, new recommendation cards indicated by a dashed box 904 in c are displayed.

In an actual application, when not satisfied with recommended content of a recommendation card, the user may update the recommendation card to display a new recommendation card, which improves user experience, enriches recommended content, and also improves human-computer interaction efficiency and utilization of hardware processing resources.

During actual implementation, after the recommendation cards are respectively updated to new recommendation cards, the new recommendation cards may further be controlled to be in a clustered state; a process of moving the new recommendation cards from initial positions to target positions is displayed when the new recommendation cards in the clustered state satisfy a separation condition, and the new recommendation cards are controlled to be in a separated state when the new recommendation cards are all at the target positions.

The separation condition herein is similar to the separation condition described above. In addition, the displaying a process of moving the new recommendation cards from initial positions to target positions is also similar to the displaying a process of moving the recommendation cards from the initial positions to target positions described above. This is not described in detail in this embodiment of this disclosure.

For example, still referring to FIG. 9 and referring to FIG. 10, FIG. 10 is a schematic diagram of new recommendation cards in a separated state according to an embodiment of this disclosure. Based on FIG. 9 and FIG. 10, after the new recommendation cards as indicated by the dashed box 904 in c in FIG. 9 are displayed, that is, after the new recommendation cards are controlled to be in a clustered state, when the new recommendation cards in the clustered state satisfy the separation condition, the displaying a process of moving the new recommendation cards from initial positions to target positions is displaying new recommendation cards in a separated state as indicated by a dashed box 1001 in FIG. 10.

In some embodiments, alternatively, the recommendation cards may be updated by using another operation. Specifically, when the recommendation cards are all at the target positions, after the at least two recommendation cards in the separated state are presented, the at least two recommendation cards may alternatively be updated when a left or right slide operation on the at least two recommendation cards in the separated state is received, to obtain at least two new recommendation cards, and the at least two new recommendation cards in a separated state are presented. Alternatively, when the left or right slide operation on a target recommendation card of the at least two recommendation cards in the separated state is received, the target recommendation card is updated, to obtain a new target recommendation card.

When the left or right slide operation is received, a sliding distance of the left or right slide operation is detected, and when a detection result represents that the sliding distance of the left or right slide operation reaches a sliding distance threshold, a sliding region of the left or right slide operation is detected, to obtain a detection result; when the detection result represents that the slide region is associated with the at least two recommendation cards, the left or right slide operation is determined as a left or right slide operation on the at least two recommendation cards in the separated state, so as to update the at least two recommendation cards in response to the left or right slide operation on the at least two recommendation cards in the separated state, to obtain at least two new recommendation cards, and the at least two new recommendation cards in a separated state are presented; and when the detection result represents that the slide region is associated with one recommendation card, the left or right slide operation is determined as a left or right slide operation on a target recommendation card of the at least two recommendation cards in the separated state; in response to the left or right slide operation on the target recommendation card of the at least two recommendation cards in the separated state, the one recommendation card associated with the left or right slide operation, that is, the target recommendation card, is updated, to obtain a new target recommendation card, and new recommendation cards in a separated state and at least one non-updated recommendation card are presented.

In an actual application, the target recommendation card is updated by using a slide operation on the target recommendation card. When the user is unsatisfied with recommended content of a recommendation card, the recommendation card can be accurately updated, which improves a recommendation effect and recommendation efficiency of recommendation cards and also improves user experience and human-computer interaction efficiency.

In some embodiments, a recommendation card may further be updated by using a presentation duration of the recommendation card. Specifically, after the at least two recommendation cards in the separated state are presented when the recommendation cards are all at the target positions, a third presentation duration of the at least two recommendation cards in the separated state may further be displayed; and the at least two recommendation cards are updated when the third presentation duration reaches a target third presentation duration, to obtain at least two new recommendation cards. The target third presentation duration may be preset.

By applying the foregoing embodiments, when the third presentation duration of the at least two recommendation cards reaches the target third presentation duration, the recommendation card is automatically updated, which improves update efficiency of the recommendation card and also can improve convenience of an update process of the recommendation card, so that when it is inconvenient for the user to actively trigger an update operation on the recommendation card, the recommendation card can still be updated, thereby further improving the user experience.

In some embodiments, when the recommendation card is updated, an initial position of the new recommendation card may be the same as the initial position of the corresponding recommendation card before the update, or may be different from the initial position of the corresponding recommendation card before the update.

During actual implementation, when the initial positions of the new recommendation cards are different from the initial positions of the corresponding recommendation cards before the update, a process of determining the initial positions of the new recommendation cards may be: acquiring values of coordinate update adjustment parameters corresponding to the new recommendation cards; and acquiring, for the new recommendation cards, target coordinates of the recommendation cards before the update based on the values of the coordinate update adjustment parameters corresponding to the new recommendation cards; and adjusting the target coordinates of the recommendation cards before the update, to obtain initial coordinates of the new recommendation cards in the interface coordinate system; and determining the initial positions of the new recommendation cards in the recommendation interface based on the initial coordinates of the new recommendation cards in the interface coordinate system.

The coordinate update adjustment parameters corresponding to each new recommendation card also include Δx and Δy, and the values of the coordinate update adjustment parameters may be preset. For example, referring to FIG. 11, FIG. 11 is a schematic diagram of initial coordinates of new recommendation cards according to an embodiment of this disclosure. Based on FIG. 11, a dashed box 1101 in FIG. 11 indicates values of horizontal coordinates and values of vertical coordinates of the initial coordinates of the new recommendation cards. Taking a new recommendation card 1 and a new recommendation card 2 as examples, coordinate update adjustment parameters Δx=N₁ and Δy=0 corresponding to the new recommendation card 1 are acquired, and target coordinates of a recommendation card before update corresponding to the new recommendation card are (152, 324). Therefore, based on the values of the coordinate update adjustment parameters corresponding to the new recommendation card 1, the target coordinates (152, 324) of the recommendation card before update corresponding to the new recommendation card 1 are adjusted, to obtain initial coordinates (152+N₁, 324) of the new recommendation card in the interface coordinate system. For the new recommendation card 2, coordinate update adjustment parameters Δx=0 and Δy=0 corresponding to the new recommendation card 2 are acquired, and target coordinates of a recommendation card before update corresponding to the new recommendation card 2 are (226, 468), so as to adjust the target coordinates (226, 468) of the recommendation card before update corresponding to the new recommendation card 2 based on the values of the coordinate update adjustment parameters corresponding to the new recommendation card 2, to obtain initial coordinates (226, 468) of the new recommendation card in the interface coordinate system. N₁ denotes a random integer value within a target interval range such as [−120, −60] and [60, 120]. Correspondingly, when the coordinates of the recommendation card change, an angle of the recommendation card also changes, so that N₂ is determined based on N₁, which may be, for example, a random integer value within [−12°, −6°] and [6°, 12°].

During actual implementation, when the initial position of the new recommendation card is different from the initial position of the corresponding recommendation card before the update, the displaying a process of moving the new recommendation cards from initial positions to target positions is also similar to the displaying a process of moving the recommendation cards from the initial positions to target position described above. This is not described in detail in this embodiment of this disclosure.

In some embodiments, when the clustered state is obtained by displaying the at least two recommendation cards in a superimposing manner, after the at least two recommendation cards in the clustered state are presented, a playback control may further be displayed when the recommended content includes recommended video content or recommended audio content; and starting from the topmost recommendation card and based on the superimposing sequence of the at least two recommendation cards, the recommended content of the recommendation cards is sequentially played back in response to a trigger operation on the playback control.

As an example, still referring to FIG. 5, a control indicated by 503 in FIG. 5 is a playback control. Therefore, when the recommended content includes recommended video content or recommended audio content, the playback control indicated by 503 in FIG. 5 is displayed, so as to sequentially play back, starting from the topmost recommendation card based on a superimposing sequence of the at least two recommendation cards, the recommended content of the recommendation cards in response to a trigger operation on the playback control.

In an actual application, the recommended content of the recommendation cards may be sequentially played back based on the playback control, which improves convenience of playback of the recommended content of the recommendation cards and also improves user experience, human-computer interaction efficiency, and utilization of hardware processing resources.

By applying the foregoing embodiments of this disclosure, firstly, at least two recommendation cards in a clustered state are presented in the view interface. Then, when the at least two recommendation cards satisfy a separation condition, a process of moving the recommendation cards from initial positions to target positions is displayed, and when the recommendation cards are all at the target positions, the at least two recommendation cards in a separated state are presented. In this way, compared with the presentation manner of the recommendation cards mostly arranged in a fixed pattern, in this disclosure, when the at least two recommendation cards satisfy the separation condition, the recommendation cards are controlled to move from the initial positions to the target positions, to switch the recommendation cards from the clustered state to the separated state, thereby implementing dynamic presentation of the recommendation cards, which enriches diversity of a presentation process of the recommendation cards, improves utilization of the recommendation cards, human-computer interaction efficiency, and utilization of hardware processing resources, and can also better attract users, helping to improve conversion efficiency of recommended content carried in the recommendation cards.

Next, an example of an application of this embodiment of this disclosure in an actual application scenario will be described.

In a related technology, when recommendation cards are presented, the recommendation cards are mostly arranged in a fixed pattern. Then, different recommendation resources are fetched from a server end to refresh content with which the recommendation cards are filled. However, such a recommendation card presentation manner results in a lack of variation and recognizability in recommendation slots. The user cannot form a memorization point and interest in such a presentation manner, and the user can only be attracted by relying solely on the recommended content, which is not conducive to improving conversion efficiency of promotion of recommended content.

Based on this, an embodiment of this disclosure provides a solution of dynamically presenting recommended content, in which angular and displacement transformations of a plurality of sets of recommended content slots are calculated by using brand-new arrangement of presentation slots and dynamic presentation strategies, and then are combined with refreshable server-end recommendation strategies to achieve a novel, interactive, and brand-recognizable recommendation slot presentation form.

Next, the technical solution of this disclosure will be described from a product perspective.

During actual implementation, a recommendation interface is first displayed in response to a display instruction for the recommendation interface, so that recommendation cards are displayed in the recommendation interface. A process of displaying the recommendation cards may be: acquiring a first group of recommended content information from a server, and then generating at least two recommendation cards based on the acquired first group of recommended content information, so as to display the recommendation cards. Herein, the displayed recommendation cards are in a clustered state, as shown in a in FIG. 5.

Then, when the recommendation cards need to be separated (satisfy the separation condition), end states (target positions) of the recommendation cards are determined according to position data (coordinates) of the recommendation cards, a process of moving the recommendation cards from the initial positions to the target positions is displayed, and the recommendation cards in the separated state are presented when the recommendation cards are all at the target positions, as shown in b in FIG. 5.

Next, in response to a trigger operation on a “refresh” control (card update control), position data (initial positions) of new recommendation cards is calculated according to the end states of the recommendation cards. Then, end states (target positions) of the new recommendation cards are calculated according to the position data of the new recommendation cards. Specifically, in response to the trigger operation on the “refresh” control (card update control), the position data (initial positions) of the new recommendation cards is calculated, and a process of collapsing the recommendation cards is displayed, that is, a process of converting the recommendation cards from the end states to initial states (initial positions) is displayed, so that when the recommendation cards are all in the initial states, the recommendation cards are respectively updated to new recommendation cards, and the end states (target positions) of the new recommendation card are calculated according to the position data of the new recommendation cards, so as to display a process of moving the new recommendation cards from the initial positions to the target positions.

As shown in FIG. 9 and FIG. 10, in response to the trigger operation on the card update control indicated by 901 in a, a process of moving the recommendation cards in the dashed box 902 from the target positions to the initial positions is displayed, so as to display the recommendation cards indicated by the dashed box 903 in b, so that when the recommendation cards are all at the initial positions, the recommendation cards are respectively updated to new recommendation cards, that is, the new recommendation cards as indicated by the dashed box 904 in c are displayed, and then after the new recommendation cards as indicated by the dashed box 904 in c in FIG. 9 are displayed, a process of moving the new recommendation cards from the initial positions to the target positions is displayed, that is, the new recommendation cards in a separated state as indicated by the dashed box 1001 in FIG. 10 are displayed.

In an actual application, a quantity of the recommendation cards and recommendation types and content carried in the recommendation cards may be set based on a user requirement, which are not limited in this embodiment of this disclosure.

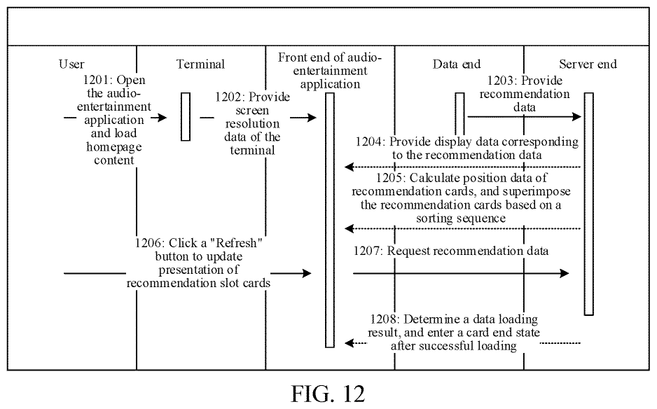

Next, the technical solution of this disclosure will be described from a technical perspective. Referring to FIG. 12, FIG. 12 is a schematic flowchart of a solution of dynamically presenting recommended content according to an embodiment of this disclosure. Based on FIG. 12, the technical solution provided in this embodiment of this disclosure may be implemented by using operation 1201 to operation 1208. Specifically, firstly, the terminal runs an audio-entertainment application in response to a running instruction for the audio-entertainment application and loads homepage content, then the terminal transmits screen resolution data (an interface dimension) of the terminal to a front end of the audio-entertainment application, and at the same time, a data end provides the recommendation data for the server end, so that the server end transmits display data corresponding to the recommendation data to the front end of the audio-entertainment application, calculates position data of recommendation cards based on the recommendation data, and superimposes the recommendation cards based on a sorting sequence, to obtain recommendation card combinations, and then transmits the recommendation card combinations to the front end of the audio-entertainment application, to cause the front end of the audio-entertainment application to display the recommendation cards based on a superimposing sequence of the recommendation card combinations and the display data corresponding to the recommendation data. Next, the front end of the audio-entertainment application in the terminal refreshes the recommendation cards and requests refreshed recommendation data from the server end when receiving a trigger operation performed by the user on the “refresh” control, so that the server end transmits the refreshed recommendation data to the front end of the audio-entertainment application based on a request and transmits end states of new recommendation cards obtained by calculation to the front end of the audio-entertainment application when the front end of the audio-entertainment application successfully loads the refreshed recommendation data, to cause the front end of the audio-entertainment application to display the process of moving the new recommendation cards from the initial positions to the target positions.

During actual implementation, a process of determining the sorting sequence, that is, the superimposing sequence, of the recommendation cards may be random sorting, or may be a sorting sequence determined based on recommendation degrees of the recommendation cards, i.e., user adaptation degrees. For example, a recommendation card with the highest recommendation degree is arranged in the first layer and then sorted in descending order of the recommendation degrees.

During actual implementation, for a process of determining initial positions of cards, since display positions of the recommendation cards may vary depending on different dimensions of a current screen (recommendation interface), initial coordinates of the recommendation cards need to be determined based on dimensions (an interface dimension) of the current screen, and then initial positions of the recommendation cards are determined based on the initial coordinates corresponding to the recommendation cards. Based on this, the interface dimension of the current screen is acquired, and values of change parameters corresponding to the recommendation cards are determined based on the interface dimension; coordinates of the recommendation cards are acquired, and an interface coordinate system of the corresponding recommendation interface is constructed; and for each recommendation card, the coordinates of the recommendation card are adjusted based on the value of the change parameter corresponding to the recommendation card, to obtain initial coordinates of the recommendation card in the interface coordinate system. Therefore, the initial positions of the recommendation cards on the current screen are determined based on the initial coordinates of the recommendation cards in the interface coordinate system, and the recommendation cards in a clustered state are presented at the initial positions of the recommendation interface.

A process of determining the end states may be: acquiring values of coordinate adjustment parameters corresponding to the recommendation cards; adjusting, for the recommendation cards, the initial coordinates of the recommendation cards based on the values of the coordinate adjustment parameters corresponding to the recommendation cards, to obtain target coordinates of the recommendation cards in the interface coordinate system; and determining target positions of the recommendation cards in the recommendation interface based on the target coordinates of the recommendation cards in the interface coordinate system.

The coordinate adjustment parameters corresponding to each recommendation card include Δx and Δy, and the values of the coordinate adjustment parameters may be preset. For example, referring to FIG. 6, FIG. 6 is a schematic diagram of initial coordinates and target coordinates according to an embodiment of this disclosure. Based on FIG. 6, a indicates initial coordinates of recommendation cards, the dashed box 601 indicates values of horizontal coordinates and values of vertical coordinates of the initial coordinates of the recommendation cards, b indicates target coordinates of the recommendation cards, and the dashed box 602 indicates values of horizontal coordinates and values of vertical coordinates of the target coordinates of the recommendation cards. Taking a recommendation card 1 and a recommendation card 2 as examples, initial coordinates of the recommendation card 1 are (152, 388), and corresponding coordinate adjustment parameters are Δx=0 and Δy=−64, so that the initial coordinates (152, 388) of the recommendation card 1 are adjusted based on the values of the coordinate adjustment parameters corresponding to the recommendation card 1, to obtain target coordinates (152, 324) of the recommendation card in the interface coordinate system. Initial coordinates of the recommendation card 2 are (212, 510), and corresponding coordinate adjustment parameters are Δx=14 and Δy=−42, so that the initial coordinates (212, 510) of the recommendation card 2 are adjusted based on the values of the coordinate adjustment parameters corresponding to the recommendation card 2, to obtain target coordinates (226, 468) of the recommendation card in the interface coordinate system.

For a process of determining initial random states, that is, positions of new recommendation cards, values of coordinate update adjustment parameters corresponding to the new recommendation cards are acquired; and for the new recommendation cards, position data of end states of recommendation cards before update is acquired based on the values of the coordinate update adjustment parameters corresponding to the new recommendation cards; and the position data of the end states of the recommendation cards before update is adjusted, to obtain initial coordinates of the new recommendation cards in the interface coordinate system; and initial positions of the new recommendation cards in the recommendation interface are determined based on the initial coordinates of the new recommendation cards in the interface coordinate system.

The coordinate update adjustment parameters corresponding to each new recommendation card also include Δx and Δy, and the values of the coordinate update adjustment parameters may be preset. For example, referring to FIG. 11, FIG. 11 is a schematic diagram of initial coordinates of new recommendation cards according to an embodiment of this disclosure. Based on FIG. 11, a dashed box 1101 in FIG. 11 indicates values of horizontal coordinates and values of vertical coordinates of the initial coordinates of the new recommendation cards. Taking a new recommendation card 1 and a new recommendation card 2 as examples, coordinate update adjustment parameters Δx=N₁ and Δy=0 corresponding to the new recommendation card 1 are acquired, and target coordinates of a recommendation card before update corresponding to the new recommendation card are (152, 324). Therefore, based on the values of the coordinate update adjustment parameters corresponding to the new recommendation card 1, the target coordinates (152, 324) of the recommendation card before update corresponding to the new recommendation card 1 are adjusted, to obtain initial coordinates (152+N₁, 324) of the new recommendation card in the interface coordinate system. For the new recommendation card 2, coordinate update adjustment parameters Δx=0 and Δy=0 corresponding to the new recommendation card 2 are acquired, and target coordinates of a recommendation card before update corresponding to the new recommendation card 2 are (226, 468), so as to adjust the target coordinates (226, 468) of the recommendation card before update corresponding to the new recommendation card 2 based on the values of the coordinate update adjustment parameters corresponding to the new recommendation card 2, to obtain initial coordinates (226, 468) of the new recommendation card in the interface coordinate system. N₁ denotes a random integer value within a target interval range such as [−120, −60] and [60, 120]. Correspondingly, when the coordinates of the recommendation card change, an angle of the recommendation card also changes, so that N₂ is determined based on N₁, which may be, for example, a random integer value within [−12°, −6°] and [6°, 12°].

During actual implementation, a process of determining end random states is similar to the foregoing process of determining the end states. To be specific, values of coordinate adjustment parameters corresponding to new recommendation cards are acquired; for the new recommendation cards, initial coordinates of the new recommendation cards are adjusted based on the values of the coordinate adjustment parameters corresponding to the new recommendation cards, to obtain target coordinates of the new recommendation cards in the interface coordinate system; and target positions of the new recommendation cards in the recommendation interface are determined based on the target coordinates of the new recommendation cards in the interface coordinate system.

During actual implementation, the dimensions of the screen mostly fall within three dimension ranges, that is, a first dimension range (0, 1440], a second dimension range (1440, 2028], and a third dimension range (2028, ∞). For different dimension ranges, a process of adjusting coordinates of a recommendation card based on the interface dimension of the current screen to obtain initial coordinates of the recommendation card in the interface coordinate system corresponding to the current screen varies. Next, the process of adjusting the coordinates of the recommendation card based on the interface dimension of the current screen to obtain the initial coordinates of the recommendation card in the interface coordinate system corresponding to the current screen is separately described based on the three dimension ranges.

In some embodiments, when the interface dimension of the recommendation interface falls within the dimension range of (0, 1440], a ratio of a difference among the interface dimension of the current screen, 120 (the value of the first adjustment parameter), and 48 (the value of the second adjustment parameter) to 2 (the first parameter) is acquired as a first dimension ratio, and a ratio of a difference among 1440, 120 (the value of the first adjustment parameter), and 48 (the value of the adjustment parameter) to 2 (the first parameter) is acquired as a second dimension ratio; and a ratio of the first dimension ratio to the second dimension ratio is acquired as the value of the change parameter corresponding to each recommendation card. That is,

$$k = [ ( w - 120 - 48 ) / 2 ] / [ ( 1440 - 120 - 48 ) / 2 ] , \qquad Formula ( 13 )$$

where w denotes the interface dimension of the current screen.

Then, for each recommendation card, a horizontal coordinate of the recommendation card is multiplied by the value of the change parameter based on the coordinates of the recommendation card, to obtain a first horizontal coordinate. That is,

$$x = {x}_{0} * k , \qquad Formula ( 14 )$$

where x₀ denotes a horizontal coordinate of the preset coordinates of the recommendation card.

Next, a difference between a vertical coordinate of the recommendation card and 48 (the value of the second adjustment parameter) is calculated, to obtain a difference result, and the difference result is multiplied by the value of the change parameter, to obtain a multiplication result, so that the multiplication result is summed with 48 (the value of the second adjustment parameter), to obtain a first vertical coordinate. That is,

$$y = ( {y}_{0} - 48 ) * k + 48 , \qquad Formula ( 15 )$$

where y₀ denotes a vertical coordinate of the preset coordinates of the recommendation card.

Finally, initial coordinates of the recommendation card in the interface coordinate system are obtained based on the first horizontal coordinate and the first vertical coordinate.

In some embodiments, when the interface dimension of the current screen falls within the dimension range of (1440, 2028], a ratio of a difference among the interface dimension of the current screen, 120 (the value of the first adjustment parameter), and 48 (the value of the second adjustment parameter) to 2 (the first parameter) is acquired as a third dimension ratio, and a ratio of a difference among 1440, 120 (the value of the first adjustment parameter), and 48 (the value of the second adjustment parameter) to 2 (the first parameter) is acquired as a fourth dimension ratio; and a difference between the third dimension ratio and the fourth dimension ratio is calculated to obtain a difference result, and a ratio of the difference result to 2 (the first parameter) is acquired as the value of the change parameter corresponding to each recommendation card. That is,

$$k = [ ( w - 120 - 48 ) / c - ( 1440 - 120 - 48 ) / 2 ] / 2 , \qquad Formula ( 16 )$$

where w denotes the interface dimension of the current screen.

Then, for each recommendation card, the horizontal coordinate of the recommendation card is summed with the value of the change parameter based on the coordinates of the recommendation card, to obtain a second horizontal coordinate. That is,

$$x = {x}_{0} + k , \qquad Formula ( 17 )$$

where x₀ denotes a horizontal coordinate of the preset coordinates of the recommendation card.

Next, a vertical coordinate of the recommendation card is maintained. To be specific, the vertical coordinate of the recommendation card is determined as a second vertical coordinate, so as to obtain the initial coordinates of the recommendation card in the interface coordinate system based on the second horizontal coordinate and the second vertical coordinate.

In some other embodiments, when the interface dimension of the current screen falls within the dimension range of (2028, ∞), a ratio of a difference among the interface dimension, 120 (the value of the first adjustment parameter), and 48 (the value of the second adjustment parameter) to 2 (the first parameter) is acquired as a fifth dimension ratio, and a ratio of a difference among 2028, 120 (the value of the first adjustment parameter), and 48 (the value of the second adjustment parameter) to 2 (the first parameter) is acquired as a sixth dimension ratio; and a ratio of the fifth dimension ratio to the sixth dimension ratio is acquired as the value of the change parameter corresponding to each recommendation card. That is,

$$k = [ ( w - 120 - 48 ) / 2 ] / [ ( 2028 - 120 - 48 ) / 2 ] , \qquad Formula ( 18 )$$

where w denotes the interface dimension of the current screen.

Then, for each recommendation card, a horizontal coordinate of the recommendation card is multiplied by the value of the change parameter based on the coordinates of the recommendation card, to obtain a third horizontal coordinate. That is:

$$x = {x}_{0} * k , \qquad Formula ( 19 )$$

where x₀ denotes a horizontal coordinate of the preset coordinates of the recommendation card.

Then, a difference between the vertical coordinate of the recommendation card and the value of the second adjustment parameter is calculated, to obtain a difference result, and the difference result is multiplied by the value of the change parameter, to obtain a multiplication result, and the multiplication result is summed with the value of the adjustment parameter, to obtain a third vertical coordinate. That is,

$$y = ( {y}_{0} - 48 ) * k + 48 , \qquad Formula ( 20 )$$

where y₀ denotes a vertical coordinate of the preset coordinates of the recommendation card.

Finally, the initial coordinates of the recommendation card in the interface coordinate system are obtained based on the third horizontal coordinate and the third vertical coordinate.

When the interface dimension of the current screen falls within the third dimension range, x₀ and y₀ in Formula (19) and Formula (20) may not be the horizontal coordinate and the vertical coordinate of the preset coordinates of the recommendation card, but be an intermediate horizontal coordinate and an intermediate vertical coordinate that are determined based on the horizontal coordinate and the vertical coordinate of the preset coordinates of the recommendation card. Specifically, a ratio of a difference among 2028, 120 (the value of the first adjustment parameter), and 48 (the value of the second adjustment parameter) to 2 (the first parameter) is acquired as a first intermediate dimension ratio, and a ratio of a difference among 1440, 120 (the value of the first adjustment parameter), and 48 (the value of the second adjustment parameter) to 2 (the first parameter) is acquired as a second intermediate dimension ratio; and a difference between the first intermediate dimension ratio and the second intermediate dimension ratio is calculated, to obtain a difference result, and a ratio of the difference result to 2 (the first parameter) is acquired as a value of an intermediate change parameter corresponding to each recommendation card. That is,

$${k}^{′} = [ ( 2028 - 120 - 48 ) / c - ( 1440 - 120 - 48 ) / 2 ] / 2 , \qquad Formula ( 21 )$$

Then, for each recommendation card, the horizontal coordinate of the recommendation card is summed with the value of the intermediate change parameter based on the coordinates of the recommendation card, to obtain an intermediate horizontal coordinate, that is,

$${x}^{′} = {x}_{0} + {k}^{′} , \qquad Formula ( 22 )$$

where x₀ denotes a horizontal coordinate of the preset coordinates of the recommendation card.

Then, the vertical coordinate of the recommendation card is maintained, that is, the vertical coordinate of the recommendation card is determined as an intermediate vertical coordinate, so as to substitute the intermediate horizontal coordinate and the intermediate vertical coordinate into Formula (19) and Formula (20), to determine the third horizontal coordinate and the third vertical coordinate. In this way, compared with that the third horizontal coordinate and the third vertical coordinate are directly determined based on the preset coordinates, the third horizontal coordinate and the third vertical coordinate are determined by using the intermediate vertical coordinate and the intermediate horizontal coordinate, so as to obtain the initial coordinates of the recommendation card in the interface coordinate system based on the third horizontal coordinate and the third vertical coordinate, which can enhance a widened display effect of the recommendation card on the current screen when the interface dimension of the current screen falls within the dimension range of (2028, ∞).

During actual implementation, in addition to adjusting the coordinates of the recommendation card based on the interface dimension of the current screen, presentation dimensions of the recommendation card may also be adjusted based on the interface dimension of the current screen. Specifically, an interface dimension of the current screen is acquired, and the values of the change parameters corresponding to the recommendation cards are determined based on the interface dimension; initial dimensions of the recommendation cards are acquired, and for the recommendation cards, the initial dimensions of the recommendation cards are adjusted based on the values of the change parameters corresponding to the recommendation cards, to obtain target dimensions of the recommendation cards, the target dimensions being configured to indicate card presentation dimensions matching the interface dimension of the current screen; and the at least two recommendation cards in the clustered state are presented on the current screen based on the target dimensions of the recommendation cards.

As described above, the interface dimension of the current screen mostly falls within three dimension ranges, that is, a first dimension range (0, 1440], a second dimension range (1440, 2028], and a third dimension range (2028, ∞). For different dimension ranges, the process of adjusting the coordinates of the recommendation card based on the interface dimension of the current screen to obtain the initial coordinates of the recommendation card in the interface coordinate system corresponding to the current screen varies. Correspondingly, for the different dimension ranges, the process of adjusting the initial dimensions of the recommendation card based on the interface dimension of the current screen to obtain the target dimensions of the recommendation card also varies. Next, the process of adjusting the initial dimensions of the recommendation card based on the interface dimension of the current screen to obtain the target dimensions of the recommendation card is separately described based on the three dimension ranges.

In some embodiments, when the interface dimension of the current screen falls within the dimension range of (0, 1440], a ratio of a difference among the interface dimension of the current screen, 120 (the value of the first adjustment parameter), and 48 (the value of the second adjustment parameter) to 2 (the first parameter) is acquired as a first dimension ratio, and a ratio of a difference among 1440, 120 (the value of the first adjustment parameter), and 48 (the value of the second adjustment parameter) to 2 (the first parameter) is acquired as a second dimension ratio; a ratio of the first dimension ratio to the second dimension ratio is acquired as the value of the change parameter corresponding to each recommendation card, as shown in Formula (13); then, for each recommendation card, a width of the recommendation card, that is, a dimension in the horizontal coordinate direction, is multiplied by the value of the change parameter based on dimensions of the recommendation card, to obtain a first width, as shown in Formula (11); then, a length of the recommendation card, that is, a dimension in the vertical coordinate direction, is multiplied by the value of the change parameter, to obtain a first length, as shown in Formula (12); and finally, the target dimensions of the recommendation card are obtained based on the first length and the first width.

In some embodiments, when the interface dimension of the current screen falls within the dimension range of (1440, 2028], the target dimensions of the recommendation card are the same as the initial dimensions of the recommendation card, which includes that the initial dimensions of the recommendation card remain unchanged, that is, the initial dimensions of the recommendation card are determined as the target dimensions of the recommendation card.

In some other embodiments, when the interface dimension of the current screen falls within the dimension range of (2028, ∞), a ratio of a difference among the interface dimension, 120 (the value of the first adjustment parameter), and 48 (the value of the second adjustment parameter) to 2 (the first parameter) is acquired as a fifth dimension ratio, and a ratio of a difference among 2028, 120 (the value of the first adjustment parameter), and 48 (the value of the second adjustment parameter) to 2 (the first parameter) is acquired as a sixth dimension ratio; a ratio of the fifth dimension ratio to the sixth dimension ratio is acquired as the value of the change parameter corresponding to each recommendation card, as shown in formula (18); then, for each recommendation card, a width of the recommendation card, that is, a dimension in the horizontal coordinate direction, is multiplied by the value of the change parameter based on dimensions of the recommendation card, to obtain a second width, as shown in Formula (11); and then, a length of the recommendation card, that is, a dimension in the vertical coordinate direction, is multiplied by the value of the change parameter, to obtain a second length, as shown in Formula (12). Finally, the target dimensions of the recommendation card are obtained based on the second length and the second width.

In this way, the coordinates and the dimensions of the recommendation card are dynamically adjusted based on different screen widths, that is, widths of the recommendation interface, which ensures adaptability of presentation of the recommendation card in interfaces of different dimensions, thereby enhancing a presentation effect of the recommendation card.

In this way, for the user, a novel, interactive, and brand-recognizable recommendation slot presentation form is provided for the user, thereby enhancing enjoyment of the user brought by music and visual effects in in-cabin product experience. For a developer, a flexible recommended slot presentation result can be obtained by calculating angular and displacement transformations of a plurality of sets of recommended content slots by using brand-new arrangement of recommended audio content presentation slots and dynamic presentation strategies, without a large number of complex calculations, which enhances brand recognition and builds brand awareness, and also enriches the recommended content and diversifies the presentation process of the recommendation cards, thereby being more attractive to users and helping to improve conversion efficiency of the recommended content carried in the recommendation cards.

By applying the foregoing embodiments of this disclosure, firstly, at least two recommendation cards in a clustered state are presented in the view interface. Then, when the at least two recommendation cards satisfy a separation condition, a process of moving the recommendation cards from initial positions to target positions is displayed, and when the recommendation cards are all at the target positions, the at least two recommendation cards in a separated state are presented. In this way, compared with the presentation manner of the recommendation cards mostly arranged in a fixed pattern, in this disclosure, when the at least two recommendation cards satisfy the separation condition, the recommendation cards are controlled to move from the initial positions to the target positions, to switch the recommendation cards from the clustered state to the separated state, thereby implementing dynamic presentation of the recommendation cards, which enriches diversity of a presentation process of the recommendation cards, improves utilization of the recommendation cards, human-computer interaction efficiency, and utilization of hardware processing resources, and can also better attract users, helping to improve conversion efficiency of recommended content carried in the recommendation cards.

An example of a structure of the recommendation card presentation apparatus 455 provided in the embodiments of this disclosure implemented as software modules is continuously described below. In some embodiments, as shown in FIG. 2, the software modules stored in the recommendation card presentation apparatus 455 of the memory 450 may include:
a presentation module 4551, configured to present, in a view interface, at least two recommendation cards in a clustered state, the recommendation cards being configured to carry recommended content; in the clustered state, the recommendation cards being at initial positions, and a ratio of a first area to a second area being less than a first ratio; and the first area being a sum of presented card areas of the recommendation cards, and the second area being a sum of card areas of the recommendation cards; and
a display module 4552, configured to display, when the at least two recommendation cards satisfy a separation condition, a process of moving the recommendation cards from the initial positions to target positions, and present the at least two recommendation cards in a separated state when the recommendation cards are all at the target positions; in the separated state, the ratio of the first area to the second area being no less than a second ratio, and the second ratio being greater than the first ratio.

In some embodiments, the apparatus further includes a second display module, where the second display module is configured to display a first presentation duration of the at least two recommendation cards in the clustered state; and determine, when the first presentation duration reaches a target first presentation duration, that the at least two recommendation cards satisfy the separation condition.

In some embodiments, the apparatus further includes a third display module, where the third display module is configured to display, in response to a slide operation triggered in the view interface, a slide trajectory of the slide operation; and determine, when the slide trajectory matches a target slide trajectory, that the at least two recommendation cards satisfy the separation condition.

In some embodiments, the display module 4552 is further configured to control each of the recommendation cards to break into a plurality of card fragments when the at least two recommendation cards satisfy the separation condition; and display a process of moving the card fragments of each of the recommendation cards from initial positions to target positions.

In some embodiments, the display module 4552 is further configured to display, when the card fragments of each of the recommendation cards are at the target positions, a process of combining the card fragments of each of the recommendation cards to form a complete card.

In some embodiments, the clustered state is obtained by presenting the at least two recommendation cards in a superimposing manner, and the display module 4552 is further configured to display, when the at least two recommendation cards satisfy the separation condition, a process of sequentially moving, starting from the topmost recommendation card and based on a superimposing sequence of the at least two recommendation cards presented in a superimposing manner, the recommendation cards from the initial positions to the target positions, moving speeds of the recommendation cards being inversely proportional to recommendation degrees of the corresponding recommendation cards.

In some embodiments, the display module 4552 is further configured to display, when the at least two recommendation cards satisfy the separation condition, moving trajectories corresponding to the recommendation cards in the view interface, the moving trajectories being in a special effect display state; and display a process of moving the recommendation cards from the initial positions to the target positions along the corresponding moving trajectories.

In some embodiments, the recommendation cards are located in a card recommendation region of the view interface, and the display module 4552 is further configured to control, when the at least two recommendation cards satisfy the separation condition, the card recommendation region to be displayed in a tilted manner in the view interface; and control, during the tilted display of the card recommendation region, the recommendation cards to move from the initial positions to a boundary of the view interface along a tilt direction of the card recommendation region, and control, when the recommendation cards move to the boundary of the view interface, the corresponding recommendation cards to move to the target positions.

In some embodiments, the display module 4552 is further configured to display, when the recommendation cards are at the target positions, the topmost target recommendation card in an enlarged manner based on a superimposing sequence of the at least two recommendation cards presented in a superimposing manner, and display a second presentation duration of the target recommendation card; and control, when the second presentation duration reaches a target second presentation duration, the target recommendation card to restore to an original presentation size, and display the target recommendation card and another recommendation card in a separated state, the original presentation size being configured to indicate a presentation size of the target recommendation card before the enlarged presentation, and the another recommendation card being configured to indicate a recommendation card of the at least two recommendation cards other than the target recommendation card.

In some embodiments, the apparatus further includes a fourth display module, where the fourth display module is configured to display a card update control, the card update control being configured to update at least one of the at least two recommendation cards; and update at least one of the at least two recommendation cards to a new recommendation card in response to a trigger operation on the card update control.

In some embodiments, when the card update control is configured to update all the recommendation cards, the fourth display module is further configured to display, in response to the trigger operation on the card update control, a process of moving the recommendation cards from the target positions to the initial positions; and update the recommendation cards to new recommendation cards respectively when the recommendation cards are all at the initial positions.

In some embodiments, the fourth display module is further configured to control the new recommendation cards to be in a clustered state; and display, when the new recommendation cards in the clustered state satisfy the separation condition, a process of moving the new recommendation cards from initial positions to target positions, and control the new recommendation cards to be in a separated state when the new recommendation cards are all at the target positions.

In some embodiments, the apparatus further includes an update module, where the update module is configured to update, when a left or right slide operation on the at least two recommendation cards in the separated state is received, the at least two recommendation cards to obtain at least two new recommendation cards, and present the at least two new recommendation cards in a separated state; and update, when a switch operation on a target recommendation card of the at least two recommendation cards in the separated state is received, the target recommendation card to obtain a new target recommendation card.

In some embodiments, the clustered state is obtained by presenting the at least two recommendation cards in a superimposing manner, and the apparatus further includes a fifth display module, where the fifth display module is configured to display a playback control when the recommended content includes recommended video content or recommended audio content; and sequentially play back, starting from the topmost recommendation card based on the superimposing sequence of the at least two recommendation cards, the recommended content of the recommendation cards in response to a trigger operation on the playback control.

In some embodiments, the display module 4551 is further configured to acquire, when the view interface is a recommendation interface, an interface dimension of the recommendation interface, and determine, based on the interface dimension, values of change parameters corresponding to the recommendation cards; acquire initial dimensions of the recommendation cards, and adjust, for the recommendation cards, the initial dimensions of the recommendation cards based on the values of the change parameters corresponding to the recommendation cards, to obtain target dimensions of the recommendation cards, the target dimensions being configured to indicate card presentation dimensions matching the interface dimension of the recommendation interface; and present, in the recommendation interface, the at least two recommendation cards in the clustered state based on the target dimensions of the recommendation cards.

In some embodiments, the display module 4551 is further configured to acquire, when the view interface is a recommendation interface, an interface dimension of the recommendation interface, and determine, based on the interface dimension, values of change parameters corresponding to the recommendation cards; construct an interface coordinate system corresponding to the recommendation interface, and acquire coordinates of the recommendation cards in the interface coordinate system; adjust, for the recommendation cards, the coordinates of the recommendation cards based on the values of the change parameters corresponding to the recommendation cards, to obtain initial coordinates of the recommendation cards in the interface coordinate system; and determine initial positions of the recommendation cards in the recommendation interface based on the initial coordinates of the recommendation cards in the interface coordinate system, and present the at least two recommendation cards in the clustered state at the initial positions of the recommendation interface.

In some embodiments, the display module 4551 is further configured to acquire values of coordinate adjustment parameters corresponding to the recommendation cards; adjust, for the recommendation cards, the initial coordinates of the recommendation cards based on the values of the coordinate adjustment parameters corresponding to the recommendation cards, to obtain target coordinates of the recommendation cards in the interface coordinate system; and determine target positions of the recommendation cards in the recommendation interface based on the target coordinates of the recommendation cards in the interface coordinate system.

In some embodiments, the apparatus further includes a sixth display module, where the sixth display module is configured to display a third presentation duration of the at least two recommendation cards in the separated state; and update the at least two recommendation cards when the third presentation duration reaches a target third presentation duration, to obtain at least two new recommendation cards.

In some embodiments, the apparatus further includes a seventh display module, where the seventh display module is configured to display an interactive element; and determine, in response to a card separation operation triggered based on the interactive element, that the at least two recommendation cards satisfy the separation condition.

An embodiment of this disclosure provides a computer program product or a computer program. The computer program product or the computer program includes a computer instruction, and the computer instruction is stored in a computer-readable storage medium. A processor of an electronic device reads the computer-executable instruction from the computer-readable storage medium, and the processor executes the computer-executable instruction, to enable the electronic device to perform the recommendation card presentation methods provided in the embodiments of this disclosure.

An embodiment of this disclosure provides a computer-readable storage medium (e.g., a non-transitory computer-readable storage medium) having executable instructions stored therein. When the executable instructions are executed by a processor, the processor is caused to perform the recommendation card presentation methods provided in the embodiments of this disclosure, for example, the recommendation card presentation method shown in FIG. 3.

In some embodiments, the computer-readable storage medium may be a memory such as a ROM, a RAM, an erasable programmable read-only memory (EPROM), an electrically erasable programmable read-only memory (EEPROM), a flash memory, a magnetic surface memory, an optical disc, or a CD-ROM; or may be various devices including one or any combination of the foregoing memories.

In some embodiments, the executable instructions may be written in a form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

For example, the executable instructions may, but do not necessarily, correspond to a file in a file system, and may be stored in a part of a file that saves another program or other data, for example, be stored in one or more scripts in a hypertext markup language (HTML) file, stored in a file that is specially configured for a program in discussion, or stored in the plurality of collaborative files (for example, be stored in files of one or modules, subprograms, or code parts).

In an example, the executable instructions may be deployed to be executed on an electronic device, or deployed to be executed on a plurality of electronic devices at the same location, or deployed to be executed on a plurality of electronic devices that are distributed in a plurality of locations and interconnected by using a communication network.

In conclusion, the embodiments of this disclosure include the following beneficial effects:
(1) Compared with the presentation manner of the recommendation cards mostly arranged in a fixed pattern, in this disclosure, when the at least two recommendation cards satisfy the separation condition, the recommendation cards are controlled to move from the initial positions to the target positions, to switch the recommendation cards from the clustered state to the separated state, thereby implementing dynamic presentation of the recommendation cards, which enriches diversity of a presentation process of the recommendation cards, improves utilization of the recommendation cards, human-computer interaction efficiency, and utilization of hardware processing resources, and can also better attract users, helping to improve conversion efficiency of recommended content carried in the recommendation cards.
(2) Compared with that the third horizontal coordinate and the third vertical coordinate are directly determined based on the preset coordinates, the third horizontal coordinate and the third vertical coordinate are determined by using the intermediate vertical coordinate and the intermediate horizontal coordinate, so as to obtain the initial coordinates of the recommendation card in the interface coordinate system based on the third horizontal coordinate and the third vertical coordinate, which can enhance a widened display effect of the recommendation card on the recommendation interface when the interface dimension of the recommendation interface is relatively large.
(3) The coordinates and the dimensions of the recommendation card are dynamically adjusted based on different screen widths, that is, widths of the recommendation interface, which ensures adaptability of presentation of the recommendation card in interfaces of different dimensions, thereby enhancing a presentation effect of the recommendation card.
(4) For the user, a novel, interactive, and brand-recognizable recommendation slot presentation form is provided for the user, thereby enhancing enjoyment of the user brought by music and visual effects in in-cabin product experience. For a developer, a flexible recommended slot presentation result can be obtained by calculating angular and displacement transformations of a plurality of sets of recommended content slots by using brand-new arrangement of recommended audio content presentation slots and dynamic presentation strategies, without a large number of complex calculations, which enhances brand recognition and builds brand awareness, and also enriches the recommended content and diversifies the presentation process of the recommendation cards, thereby being more attractive to users and helping to improve conversion efficiency of the recommended content carried in the recommendation cards.

The foregoing descriptions are merely examples of the embodiments of this disclosure, and are not intended to limit the scope of this disclosure. Any modification, equivalent replacement, and improvement made within the spirit and scope of this disclosure fall within the scope of this disclosure.

What is claimed is:

1. A recommendation card display method, comprising:
displaying, in a view interface, at least two recommendation cards at initial positions in a clustered state, the at least two recommendation cards including recommended content, a ratio of a first area to a second area being less than a first ratio in the clustered state, the first area being a sum of visible areas of the at least two recommendation cards, and the second area being a sum of total areas of the at least two recommendation cards;
controlling, when the at least two recommendation cards satisfy a separation condition, the at least two recommendation cards to move from the initial positions to target positions; and
displaying, by processing circuitry, the at least two recommendation cards in a separated state when the at least two recommendation cards are at the target positions, wherein
in the separated state, the ratio of the first area to the second area is not less than a second ratio, the second ratio being greater than the first ratio.

2. The method according to claim 1, further comprising:
displaying a first presentation duration of the at least two recommendation cards in the clustered state; and
determining, when the first presentation duration reaches a target first presentation duration, that the at least two recommendation cards satisfy the separation condition.

3. The method according to claim 1, further comprising:
detecting, in response to a slide operation triggered in the view interface, a slide trajectory of the slide operation; and
determining, when the slide trajectory matches a target slide trajectory, that the at least two recommendation cards satisfy the separation condition.

4. The method according to claim 1, wherein the controlling comprises:
controlling, when the at least two recommendation cards satisfy the separation condition, each of the at least two recommendation cards to break into a plurality of card fragments; and
controlling the card fragments of each of the at least two recommendation cards to move from initial positions to target positions.

5. The method according to claim 4, further comprising:
combining, when the card fragments of each of the at least two recommendation cards are at the target positions, the card fragments of the recommendation card to form the at least two recommendation cards.

6. The method according to claim 1, wherein
the at least two recommendation cards are superimposed in the clustered state;
the controlling includes, when the at least two recommendation cards satisfy the separation condition, sequentially moving the at least two recommendation cards from the initial positions to the target positions starting from the topmost recommendation card and based on a superimposing sequence of the at least two recommendation cards displayed in the clustered state; and
moving speeds of the at least two recommendation cards are based on recommendation degrees of the at least two recommendation cards.

7. The method according to claim 1, wherein the controlling comprises:
determining, when the at least two recommendation cards satisfy the separation condition, moving trajectories corresponding to the at least two recommendation cards in the view interface, the moving trajectories being in a special effect display state; and
controlling the at least two recommendation cards to move from the initial positions to the target positions along the corresponding moving trajectories.

8. The method according to claim 1, wherein
the at least two recommendation cards are located in a card recommendation region of the view interface, and
the controlling comprises:
controlling, when the at least two recommendation cards satisfy the separation condition, the card recommendation region to be displayed in a tilted manner in the view interface;
controlling, during the tilted display of the card recommendation region, the at least two recommendation cards to move from the initial positions to a boundary of the view interface along a tilt direction of the card recommendation region; and
controlling, when the at least two recommendation cards move to the boundary of the view interface, the at least two recommendation cards to move to the target positions.

9. The method according to claim 1, wherein
the at least two recommendation cards are superimposed in the clustered state, and
the displaying the at least two recommendation cards in the separated state comprises:
displaying, when the at least two recommendation cards are at the target positions, the topmost target recommendation card in an enlarged manner based on a superimposing sequence of the at least two recommendation cards displayed in the clustered state;
displaying a second presentation duration of the target recommendation card;
controlling, when the second presentation duration reaches a target second presentation duration, the target recommendation card to change to an original presentation size; and
displaying the target recommendation card and another recommendation card in a separated state,
the original presentation size is a presentation size of the target recommendation card before the enlarged presentation, and
the another recommendation card is a recommendation card of the at least two recommendation cards other than the target recommendation card.

10. The method according to claim 1, further comprising:
displaying a card update control element, the card update control element being configured to cause at least one of the at least two recommendation cards to be updated; and
updating the at least one of the at least two recommendation cards to a new recommendation card in response to a trigger operation being performed on the card update control element.

11. The method according to claim 10, wherein the card update control element is configured to cause the at least two recommendation cards to be updated, the updating comprises:
controlling, in response to the trigger operation being performed on the card update control element, the at least two recommendation cards to move from the target positions to new initial positions; and
updating the at least two recommendation cards to new recommendation cards respectively when the at least two recommendation cards are at the new initial positions.

12. The method according to claim 11, further comprising:
controlling the new recommendation cards to be in the clustered state;
controlling, when the new recommendation cards in the clustered state satisfy the separation condition, the new recommendation cards to move from the new initial positions to new target positions; and
controlling the new recommendation cards to be in the separated state when the new recommendation cards are at the new target positions.

13. The method according to claim 1, further comprising:
updating, when a left or right slide operation is performed on the at least two recommendation cards in the separated state, the at least two recommendation cards to obtain at least two new recommendation cards;
displaying the at least two new recommendation cards in the separated state; and
updating, when a switch operation is performed on a target recommendation card of the at least two recommendation cards in the separated state, the target recommendation card to obtain a new target recommendation card.

14. The method according to claim 1, wherein
the at least two recommendation cards are superimposed in the clustered state, and
the method further comprises:
displaying a playback control element when the recommended content includes recommended video content or recommended audio content; and
sequentially playing back, starting from the topmost recommendation card and based on a superimposing sequence of the at least two recommendation cards, the recommended content of the at least two recommendation cards in response to a trigger operation being performed on the playback control element.

15. The method according to claim 1, wherein the displaying the at least two recommendation cards in the clustered state comprises:
acquiring an interface dimension of the view interface;
determining, based on the interface dimension, values of change parameters corresponding to the at least two recommendation cards;
adjusting initial dimensions of the at least two recommendation cards based on the values of the change parameters corresponding to the at least two recommendation cards; and
displaying, in the view interface, the at least two recommendation cards in the clustered state based on the adjusted initial dimensions of the at least two recommendation cards.

16. The method according to claim 1, wherein the displaying the at least two recommendation cards in the clustered state comprises:
acquiring an interface dimension of the view interface;
determining, based on the interface dimension, values of change parameters corresponding to the at least two recommendation cards;
constructing an interface coordinate system corresponding to the view interface;
acquiring coordinates of the at least two recommendation cards in the interface coordinate system;
adjusting, for the at least two recommendation cards, the coordinates of the at least two recommendation cards based on the values of the change parameters corresponding to the at least two recommendation cards;
determining the initial positions of the at least two recommendation cards in the view interface based on the adjusted coordinates of the at least two recommendation cards in the interface coordinate system, and
displaying the at least two recommendation cards in the clustered state at the initial positions of the recommendation interface.

17. The method according to claim 16, further comprising:
acquiring values of coordinate adjustment parameters corresponding to the at least two recommendation cards;
adjusting the initial coordinates of the at least two recommendation cards based on the values of the coordinate adjustment parameters corresponding to the at least two recommendation cards; and
determining the target positions of the at least two recommendation cards in the view interface based on the adjusted initial coordinates of the at least two recommendation cards in the interface coordinate system.

18. The method according to claim 1, further comprising:
displaying a third presentation duration of the at least two recommendation cards in the separated state; and
updating the at least two recommendation cards when the third presentation duration reaches a target third presentation duration, to obtain at least two new recommendation cards.

19. An information processing apparatus, comprising:
processing circuitry configured to:
display, in a view interface, at least two recommendation cards at initial positions in a clustered state, the at least two recommendation cards including recommended content, a ratio of a first area to a second area being less than a first ratio in the clustered state, the first area being a sum of visible areas of the at least two recommendation cards, and the second area being a sum of total areas of the at least two recommendation cards;
control, when the at least two recommendation cards satisfy a separation condition, the at least two recommendation cards to move from the initial positions to target positions; and
display the at least two recommendation cards in a separated state when the at least two recommendation cards are at the target positions, wherein
in the separated state, the ratio of the first area to the second area is not less than a second ratio, the second ratio being greater than the first ratio.

20. A non-transitory computer-readable storage medium storing instructions which when executed by at least one processor cause the at least one processor to perform a recommendation card display method, the method comprising:
displaying, in a view interface, at least two recommendation cards at initial positions in a clustered state, the at least two recommendation cards including recommended content, a ratio of a first area to a second area being less than a first ratio in the clustered state, the first area being a sum of visible areas of the at least two recommendation cards, and the second area being a sum of total areas of the at least two recommendation cards;
controlling, when the at least two recommendation cards satisfy a separation condition, the at least two recommendation cards to move from the initial positions to target positions; and
displaying the at least two recommendation cards in a separated state when the at least two recommendation cards are at the target positions, wherein
in the separated state, the ratio of the first area to the second area is not less than a second ratio, the second ratio being greater than the first ratio.
